(19) United States
(12) Patent Application Publication
(10) Pub. No.: US 2024/0251248 A1
(43) Pub. Date: Jul. 25, 2024

(54) Systems and Methods for a Radio Interface Layer Defense

(71) Applicants: SRI International, Menlo Park, CA (US); Ohio State Innovation Foundation, Columbus, OH (US)

(72) Inventors: Phillip Andrew Porras, Cupertino, CA (US); Vinod Trivandrum Yegneswaran, Foster City, CA (US); Haohuang Wen, Columbus, OH (US); Zhiqiang Lin, Columbus, OH (US)

(73) Assignee: SRI International, Menlo Park, CA (US)

(21) Appl. No.: 18/541,399

(22) Filed: Dec. 15, 2023

Related U.S. Application Data
(60) Provisional application No. 63/440,627, filed on Jan. 23, 2023.

(51) Int. Cl. H04W 12/122; H04W 4/14

(52) U.S. Cl. CPC H04W 12/122; H04W 4/14

(57) ABSTRACT

A computer-implemented method for defending, preventing, and/or mitigating short message service (SMS) based activities is provided. The method includes monitoring, by a security component in a radio interface layer (RIL) of a computing device configured to access a radio network, data related to SMS interactions over the radio network. The method also includes, based on the monitoring, detecting a potential activity associated with an SMS interaction. The method additionally includes providing an indication of the potential activity.

### CROSS-REFERENCE TO RELATED APPLICATIONS

This application claims priority to U.S. Provisional Patent Application No. 63/440,627, titled “Radio Interface Layer Defense,” filed on Jan. 23, 2023, which is hereby incorporated by reference in its entirety.

### BACKGROUND

The short message service (SMS) is used in smartphone communications and enables inter-personal text messaging and other SMS-based services (e.g., two-factor authentication). However, SMS can be exploited to compromise unsuspecting victims. For instance, exploits such as Simjacker and Wireless Internet Browser Attack (WIBAttack) enable transmission of binary SMS messages that may be configured to surreptitiously execute exploitative commands on a victim device. The SMS channel may also be subverted to drive other nefarious activities (e.g., spamming, DoS, and tracking), thereby undermining end-user security and privacy. Existing smartphone operating systems or existing defense techniques fail to provide a comprehensive bulwark against the spectrum of evolving SMS-driven threats.

### SUMMARY

To address this limitation, a framework for defending, preventing, and/or mitigating short message service (SMS) based activities is described herein. The framework may involve a security component that communicates with a cellular processor in a baseband and an application processor in a kernel, to monitor data related to SMS interactions over a radio network, detect a potential activity associated with an SMS interaction, and provide an indication of the potential activity. The security component may be configured to perform a security mediation service the cellular processor, where the baseband firmware is executed, and the application processor, where the operating system is executed.

Although the defense framework is applicable over any operating system, in the context of Android devices, the framework may sometimes be referred to as “RILDEFENDER,” which is an inline prevention system integrated into a radio interface layer (RIL) of the Android devices. Generally, the RIL acts as a shared memory resource between the baseband and a kernel. For illustrative purposes, an example implementation of RILDEFENDER on three smartphone models with five Android versions of the Android Open Source Project (AOSP) is described. The example implementation demonstrates that RILDEFENDER is able to protect users from six types of SMS attacks spanning four adversary models. RILDEFENDER may be evaluated against nineteen (19) reproduced SMS attacks and eleven (11) contemporary SMS malware samples. The evaluations indicate that RILDEFENDER may be capable of detecting and automatically preventing such threats without affecting normal cellular operations.

In a first aspect, a computer-implemented method for defending, preventing, and/or mitigating short message service (SMS) based activities is provided. The method includes monitoring, by a security component in a radio interface layer (RIL) of a computing device configured to access a radio network, data related to SMS interactions over the radio network. The method also includes, based on the monitoring, detecting a potential activity associated with an SMS interaction. The method additionally includes providing an indication of the potential activity.

In a second aspect, a computing device for defending, preventing, and/or mitigating short message service (SMS) based activities is provided. The computing device includes a one or more processors, and data storage. The data storage has stored thereon computer-executable instructions that, when executed by the one or more processors, cause the computing device to perform operations. The operations include monitoring, by a security component of the computing device, data related to SMS interactions over a radio network, wherein the security component is located in an abstraction layer between radio hardware and an operating system (OS). The operations also include, based on the monitoring, detecting a potential activity associated with an SMS interaction. The operations additionally include providing an indication of the potential activity.

In a third aspect, a non-transitory computer-readable medium for defending, preventing, and/or mitigating short message service (SMS) based activities is provided. The non-transitory computer-readable medium includes program instructions executable by one or more processors to cause the one or more processors to perform operations. The operations include monitoring, by a security component of a computing device, data related to SMS interactions over a radio network, wherein the security component is located in an abstraction layer between radio hardware and an operating system (OS). The operations also include, based on the monitoring, detecting a potential activity associated with an SMS interaction. The operations additionally include providing an indication of the potential activity.

In a fourth aspect, a system or defending, preventing, and/or mitigating short message service (SMS) based activities is provided. The system includes one or more processors, and data storage. The data storage has stored thereon computer-executable instructions that, when executed by the one or more processors, cause the computing device to perform operations. The operations include monitoring, by a security component of the computing device, data related to SMS interactions over a radio network, wherein the security component is located in an abstraction layer between radio hardware and an operating system (OS). The operations also include, based on the monitoring, detecting a potential activity associated with an SMS interaction. The operations additionally include providing an indication of the potential activity.

### BRIEF DESCRIPTION OF THE FIGURES

FIG. 1A illustrates an example exchange of SMS messages by end-user devices over cellular networks, in accordance with example embodiments.

FIG. 1B illustrates an example structure of an SMS message, in accordance with example embodiments.

FIG. 2A is a block diagram illustrating an example architecture for an abstraction layer between radio hardware and an operating system (OS), in accordance with example embodiments.

FIG. 2B is a block diagram illustrating an example architecture for a radio interface layer, in accordance with example embodiments.

FIG. 3 displays a table listing example SMS attacks targeting user devices, in accordance with example embodiments.

FIG. 4 displays a table listing example existing defenses against SMS attacks targeting user devices, in accordance with example embodiments.

FIG. 5 illustrates an architecture of RILDEFENDER deployed at a radio interface layer (RIL) and an application layer, in accordance with example embodiments.

FIG. 6 displays a table listing example SMS features collected at a radio interface layer (RIL), in accordance with example embodiments.

FIG. 7 displays high-level examples of propositional logic-based SMS attack signatures, in accordance with example embodiments.

FIG. 8 illustrates an abstract workflow for inbound SMS processing at the RIL, in accordance with example embodiments.

FIG. 9 illustrates an abstract workflow for outbound SMS processing at the RIL, in accordance with example embodiments.

FIG. 10 displays a table illustrating raw Protocol Data Unit (PDU) payload for example SMS test cases, in accordance with example embodiments.

FIG. 11 is an example high-level workflow of an interactive binary SMS attack, in accordance with example embodiments.

FIG. 12 is an example high-level workflow of a non-interactive binary SMS attack, in accordance with example embodiments.

FIG. 13 illustrates an example detection and mitigation of malware SMS, in accordance with example embodiments.

FIG. 14 displays table listing details of the implementations, in accordance with example embodiments.

FIG. 15 displays table illustrating SMS test cases, in accordance with example embodiments.

FIG. 16 displays table illustrating malware SMS test cases, in accordance with example embodiments.

FIG. 17 depicts a network environment, in accordance with example embodiments.

FIG. 18 depicts a protocol stack, in accordance with example embodiments.

FIG. 19 is a block diagram of an example computing device, in accordance with example embodiments.

FIG. 20 illustrates an example method, in accordance with example embodiments.

### DETAILED DESCRIPTION

The Short Message Service (SMS) is a low-bandwidth text-based transmission protocol that was introduced prior to the advent of smart Internet-connected mobile devices. The SMS service may be used in a variety of ways that are opaque to mobile phone users. Particularly, the SMS service may be weaponized in ways that violate users' privacy and security, including SMS functions that may be surreptitiously inserted into the subscriber identity module (SIM) supply chain and remain undocumented by mobile providers.

Although SMS is primarily used a text-based service, as an SMS message may carry binary attachments that can cause vulnerable SIMs to execute dangerous operations on a smartphone without the recipient's awareness or consent. An attacker can thus exploit this vulnerability by crafting binary-embedded SMS messages and delivering them to users. Such messages can result in covert dialing, sending of SMS, the opening of a browser with a specified URL, and/or an execution of Attention (AT) commands. Two instances of such binary SMS attacks are Simjacker and WIBAttack, affecting mobile users in several countries worldwide. Launching such an attack can be easy, as a pre-paid SIM and a GSM-compatible USB modem, both being available and inexpensive, are sufficient to configure the attack.

Other exploit paths exist within the SMS protocol that can violate a mobile user's privacy and security. For example, silent and flash SMS messages are two types of SMS that are used by mobile operators and governments to track a smartphone owner's geo-position or to post emergency alerts, respectively. However, silent and flash SMS messages can also be exploited by a larger pool of adversaries to perform tracking and denial-of-service (DOS) attacks against mobile devices. Fraudulent and spammed SMS messages can also be sent from a GSM fake base station (FBS) to impersonate a legitimate source in order to spoof the recipient. The increasing availability of recent software stacks and software-defined radio hardware, makes such attack campaigns more accessible to unsophisticated adversaries. For example, FBS SMS represents widespread threats within some countries and causes billions in monetary loss per year.

SMS has also been exploited as a communication medium that enables malware-infected phones to receive instructions, exfiltrate data from infected mobile devices, and accelerate malware propagation. Mobile malware developers are increasingly adept at luring users to install and grant privileges to devices, for example, by masquerading their malware as legitimate postal-service apps, and/or COVID-19 notification apps. Once the malware is trusted by the user, SMS offers adversaries a channel to rapidly spread malicious links to other users in the victim's contact list. The recipients are more likely to access these links as they originate from a known source.

Efforts on defenses designed to help end users detect malicious SMS attacks may be broadly categorized into two classes. The first class includes device-centric defenses, which install additional software plug-ins to mobile devices. For example, Android-based monitoring apps can detect silent SMS and FBS attacks. The second class includes network-based defense, which involves the deployment of cellular hardware infrastructures within the radio access network to monitor cellular traffic. For instance, city-wide cellular network monitors may be deployed to hunt for malicious FBS messages. While such approaches help end-users understand the prevalence of certain SMS attacks, the approaches suffer from several limitations. For example, many defenses focus on passive detection and produce alerts for attacks that are observed. Also, for example, the defenses often have poor scalability, e.g., network-based solutions require the deployment of hardware infrastructures at a large scale. As another example, existing solutions do not comprehensively address the aforementioned SMS attacks, such as Simjacker, WIBAttack, and SMS messages generated from proactive SIMs.

### Overview

As described herein, a system-level defensive framework may be configured as an inline prevention system integrated into the smartphone OS for defending, preventing, and/or mitigating short message service (SMS) based activities. The term “defending,” may generally refer to resisting an attack by a hostile actor. For example, a hostile actor may access a mobile device and delete a critical file. A security program may detect that a process being run deleted the critical file. Accordingly, defending can involve terminating the process to defend the device.

The term “preventing,” may generally refer to a prevention of existing and/or future, actual and/or potential malicious activities. For example, in the example scenario above, the security program may detect that a process being run is deleting the critical file. Accordingly, protecting can involve interrupting the deletion of the file and terminating the process. The security program thus prevents deletion of the critical file, and also protects against further malicious activity by the process.

The term “mitigating,” may generally refer reducing a severity, seriousness, and/or threat level of existing and/or future, actual and/or potential malicious activities. However, in some contexts, such as in the field of network security, the term “mitigating” may be used more broadly to cover “preventing,” and/or “defending.” Mitigation may involve strategies that limit an impact of harmful activities.

In an Android OS, the inline prevention system described herein may involve a Radio Interface Layer (RIL). RILDEFENDER may be configured to address a wide range of SMS attacks and offer several advantages over existing SMS defense technologies. First, unlike existing SMS defenses, RILDEFENDER provides the capability to detect SMS attacks and also intercede (block) them automatically in real-time. Second, RILDEFENDER's deployment at the RIL makes it agnostic to a wide range of vendor-specific smartphone OSs. Third, RILDEFENDER is designed to be extensible to new SMS threats by providing user-configurable attack signatures and policies. This approach may involve inline threat mitigation rules for six types of SMS attacks from four different adversary classes.

In some embodiments, a prototype of RILDEFENDER may be integrated as an extension to the Android Open-Source Project (AOSP). For example, RILDEFENDER may be implemented and tested on three representative Android smartphone models with five legacy and more recent Android OS versions (e.g., up to Android 13). To evaluate RILDEFENDER's robustness against the six types of SMS threats, known attacks may be used in an SMS testbed atop a BladeRF 2.0 software-defined radio. RILDEFENDER may be tested against 19 reproduced SMS attack cases, 11 SMS malware samples, and real-world SMS traces of 7-days. RILDEFENDER appears to have the capability to accurately prevent such attacks, while not affecting normal cellular operations. Also, for example, RILDEFENDER may impose acceptable overhead in terms of power consumption, memory, storage, and computation. In a worst-case scenario, RILDEFENDER may impose a 1% battery consumption per hour and a 100 ms delay on cellular operations for our tested devices. Further, RILDEFENDER can potentially be extended to support SMS over IP Multimedia Subsystem (IMS), which has been widely deployed in recent 4G and 5G networks.

### Cellular Network and SMS Workflow

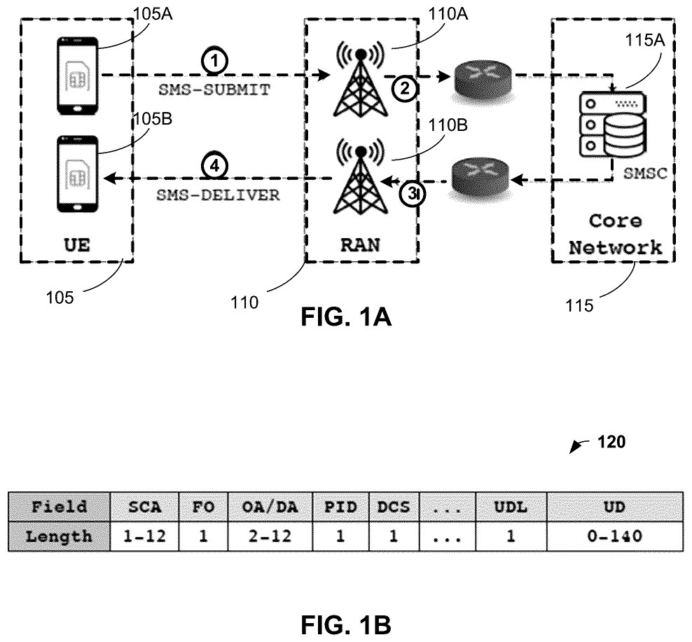

FIG. 1A illustrates an example exchange of SMS messages by end-user devices over cellular networks, in accordance with example embodiments. SMS data is exchanged between user equipment (UE) 105 such as smartphones, radio access networks (RAN) 110, and the core network 115. At step 1, a first UE 105A may initiate an SMS by sending an “SMS-SUBMIT” message to a respective subscribed first base station (BS) 110A. At step 2, the first base station 110A may relay the message to an SMS center (SMSC) 115A within the core network 115 hosted by a network provider associated with the receiving device, second UE 105B. Upon receiving the message, the SMSC 110A may repackage the message. At step 3, SMSC 110A may forward the repackaged message to a second base station 110B close to the second UE 105B. At step 4, the second base station 110B may deliver the message to the receiver's UE 105B by using an “SMS-DELIVER” message.

FIG. 1B illustrates an example structure 120 of an SMS message, in accordance with example embodiments. The respective structures of an “SMS-SUBMIT” and an “SMS-DELIVER: message may share some common information. Both messages include one or more “Field” attributes, and corresponding “Length” associated with each field attribute. For example, the message may begin with a service center address (SCA) field, indicating the SMSC address ranging from 1 to 12 bytes. Next, the first octet (FO) may include several encoded bits to convey some meta information. For example, the first MTI bit indicates whether the SMS is an SMS-SUBMIT or an SMS-DELIVER. The originator address (OA) or destination address (DA) may be specified, followed by the protocol identifier (PID) and the data coding scheme (DCS). The PID and DCS fields may define a type of SMS, such as a binary or silent SMS. Also, for example, an SMS may include variable-length user data (UD), restricted by its length (UDL) of up to 140 bytes. The UD generally includes the plain-text content of the SMS. An SMS with content longer than 140 bytes may be split into separate SMS messages and reassembled by the destination UE upon arrival.

### Security Component Memory Interface

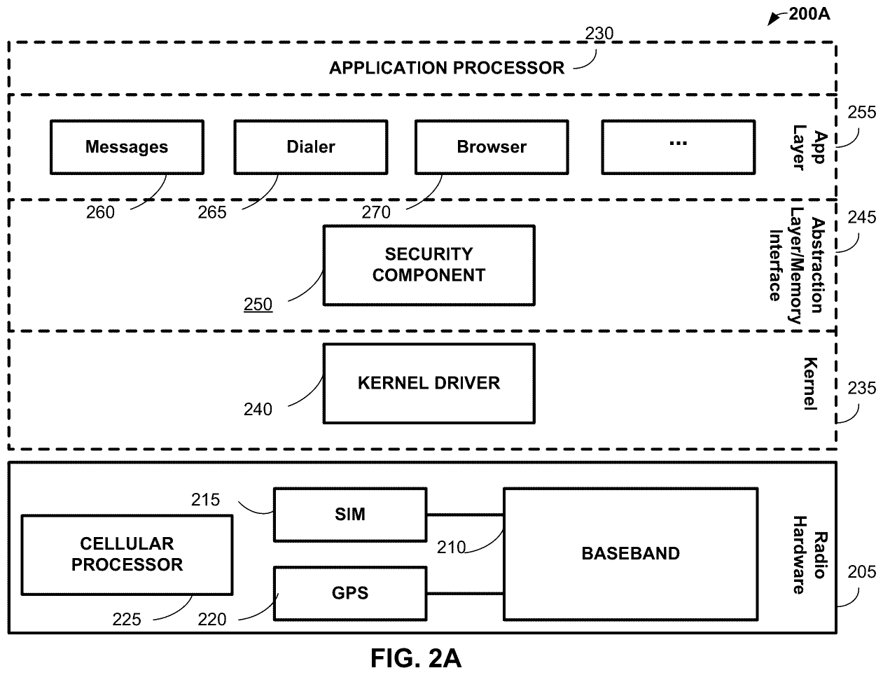

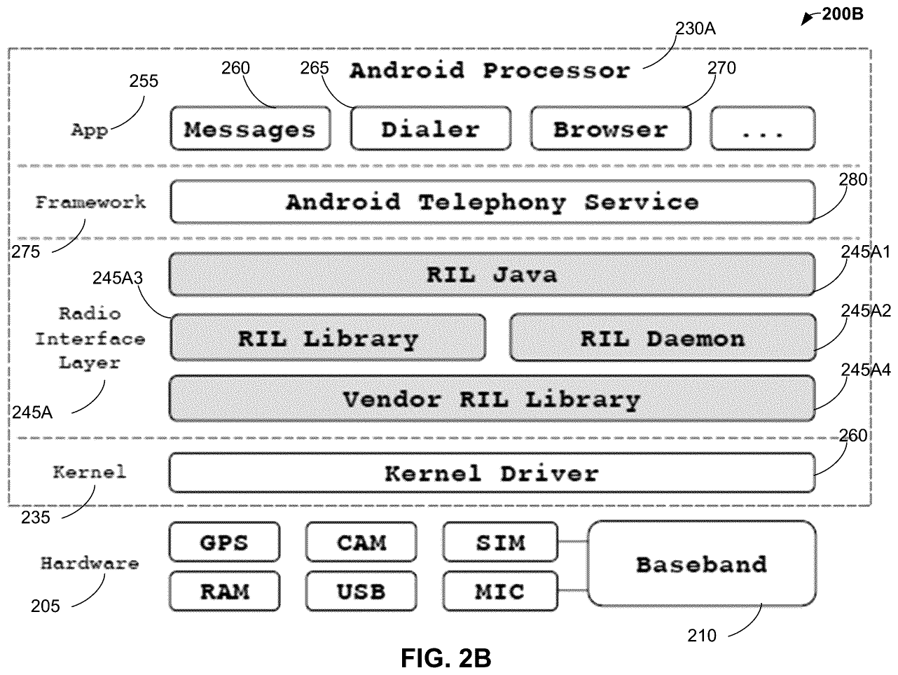

FIG. 2A is a block diagram 200A illustrating an example architecture for an abstraction layer between radio hardware and an operating system (OS), in accordance with example embodiments. In some embodiments, the operating system (OS) of the computing device may include a mobile operating system such as an ANDROID®-based OS or an APPLE®-based OS. The term “Apple-based OS” may generally refer to any operating system on an Apple platform, such as, for example, an iPhone OS (iOS®), iPadOS®, watchOS®, and so forth. As described herein, the techniques may applicable to any operating system that includes an abstraction layer to facilitate detection of activities in the baseband layer, the application layer, and/or interactions between the baseband layer and the application layer.

For example, radio hardware 205 of a user equipment (e.g., first UE 105A, second UE 105B, etc.) may include a baseband 210 and a cellular processor 225. Baseband 210 may have access to UE hardware components such as SIM 215, GPS 220. Radio hardware 205 may be configured to communicate with a base station (e.g., first base station 115A, second base station 115B, etc.). The user equipment may also include an application processor 230 configured to run an operating system to run applications. The application processor 230 may include a kernel 235 with a kernel driver 240. The application processor 230 may also include an abstraction layer 245 that includes a security component 250. The app layer 255 may include one or more applications such as messages 260, dialer 265, browser 270, and so forth.

Generally, the cellular processor 225 and the application processor 230 are configured to run separate operating systems. For example, the cellular processor 225 may run a modem OS and the application processor 230 may run the applications OS. Also, for example, the cellular processor 225 and the application processor 230 may have respective bootloaders, and separate random access memories (RAMs). Such separate and distinct components are configured so that a fault of one component does not impact operations of the other component.

The cellular processor 225 and the application processor 230 are also weakly coupled from a communications perspective. However, the two components are configured to communicate with each other using a universal asynchronous receiver/transmitter (UART) serial line (not shown) to exchange commands. The UART defines rules for exchanging serial data between the cellular processor 225 and the application processor 230.

Kernel 235 may include the UART serial line over an UNIX pseudo-terminal (e.g., in a /dev folder). An Apple-based OS may include multiple pseudo-terminals, such as, for example, /dev/mux.h5-baseband.reg, /dev/dici.h5-baseband.call, /dev/dici.h5-baseband.sms, and so forth. The Android OS generally includes one pseudo-terminal, namely /dev/smd0. Application processor 230 may open any pseudo-terminal within kernel 235 and perform input/output (I/O) commands such as “read” and “write.”

The abstraction layer in the Apple-based OS is generally referred to as the CommCenter, and the abstraction layer in the Android OS is referred to as the radio interface layer (RIL). In the Apple-based OS, the data exchanged between the cellular processor 225 and the application processor 230 may be extracted from the CommCenter using operations such as library preloading, method interposition, and from the multiple pseudo-terminals.

As described herein, the abstraction layer may be configured to monitor, by a security component, data related to SMS interactions over the radio network. Based on the monitoring, the abstraction layer may detect a potential activity associated with an SMS interaction, and provide an indication of the potential activity. Generally, the term “potential activity” may include anomalous, unusual, unexpected, harmful, and/or malicious activity, as well as routine activities performed by a mobile device in the course of processing SMS, or changes in routine activity resulting from a change in user preferences, user permissions, user signatures, and so forth.

### Radio Interface Layer

FIG. 2B is a block diagram 200B illustrating an example architecture for a radio interface layer, in accordance with example embodiments. FIG. 2B shares one or more aspects in common to FIG. 2A, and similar labels may be used for corresponding components, for illustration purposes. The radio interface layer (RIL) 245A is an Android version of abstraction layer 245 between the radio hardware 205 and the Android processor 230A. RIL 245A may include various binaries and libraries. The RIL Java component 245A1 may serve as an intermediate layer between the Android telephony service 280 in framework 275, and the native RIL libraries. For example, RIL Java component 245A1 may provide encapsulated APIs for upper telephony functions, such as dialing via dialer 265 and SMS via messages 260. RIL daemon (RILD) 245A2 may be configured to handle the life cycle of the RIL process and may communicate with the low-level radio hardware 205 (e.g., baseband 210) through the vendor RIL library 245A3. The RIL 245A may define specific commands for communication. Commands issued to the baseband 210 through the RIL 245A may be referred to as solicited commands (e.g., DIAL and HANGUP), and the commands in the reverse direction may be referred to as unsolicited commands (e.g., CALL_STATE_CHANGED and NEW_SMS). The RILD, RIL libraries 245A3, and RIL Java 245A1 are generally vendor-neutral, while vendor-specific functions and customization may be provided within each vendor or manufacturer's custom RIL library, vendor RIL library 245A4. There may be multiple ways for the vendor RIL library 245A4 to communicate with the LINUX kernel depending on the vendor's design, such as shared memory, serial communication, or TCP socket.

Cellular data may be processed by the radio hardware 205. Such an initial processing phase may be transparent to the kernel 235 as well as user-space programs in app 255. The baseband 210 may execute within an independent baseband processor (BP). The implementation of the BP may be closed-source and tamper-resistant. Once processed by the baseband 210, cellular transmissions may be converted into requests, which may be transferred to the kernel 235 in the Android processor (AP) 230A and delivered to the RIL 245A to invoke cellular functions in user-space applications 255 (e.g., messages 260, dialer 265, and browser 270). The baseband 210 may also have direct access to some UE hardware components, such as the SIM, microphone (MIC), GPS, camera (CAM), USB, RAM and so forth.

### Example Adversary Models

Adversary models can manifest violations of the privacy, integrity, and/or availability expectations of the UE owner. Generally, the baseband may be assumed to be trusted to the same extent as the underlying hardware, and protected against unauthorized modifications. Also, for illustrative purposes, the SMS attack surface is described, although similar considerations may be applicable for system- and hardware-level attacks. Also, for example, it may be assumed that the kernel, RIL, and the hardware (possibly excluding the SIM) are also trustworthy.

UE to UE (U2U) Attacks. The U2U model applies to adversaries that employ the normal cellular SMS delivery channel to transmit malicious SMS messages to target UEs. Attack transmission may occur by using a commodity USB modem (e.g., a ZTE MF833V dongle) to craft a malicious SMS in Protocol Data Unit (PDU) mode, which may be sent to the target UE. The attacker may perform such transmissions by subscribing to a mobile operator network, such as by using a prepaid SIM card. There is generally no location restriction as the SMS payload is delivered via the SMSCs. For example, adversaries may use this engagement path to deliver a binary SMS with instructions that may be interpreted and executed without the consent and awareness of the owner of the victim or target UE. For example, the adversary may target the UE's SIM, which is configured to interpret a set of instructions within the SMS binaries, leading to information theft or availability attacks against the UE.

RAN to UE (R2U) Attacks. The RAN that services communications between the UE and the core network may be vulnerable as a potential engagement path for adversaries seeking to present malicious SMS payloads to the target UE. In particular, fake base stations (FBS) have been increasingly prevalent due to the availability of cellular software stacks along with the accessibility of software-defined radios (SDRs). The R2U adversary model involves the use of an FBS as the channel to deliver SMS payloads to victim UEs. The adversary may generally trick the target UE into connecting with the FBS, by various means such as transmitting high signal power and/or downgrading the victim's device to legacy GSM network (e.g., by jamming the current network frequency). The R2U model may serve as another feasible path for U2U attacks, such as delivering a binary SMS through an FBS to nearby victims.

Internet to UE (I2U) Attacks. The I2U adversary model may involve scenarios whereby the adversary can implant malicious application logic within the target UE (such as, for example, Android malware applications) and then use the SMS service as a covert communication path. For example, SMS-based mobile botnets have demonstrated centralized and P2P SMS-based command and control (C&C) channels. Malware, such as the Android remote access tool (RAT) trojan, may also have the ability to send SMS messages to users within the phone's contact list without the owner's awareness. Accordingly, malicious applications may exploit the SMS service for their own purposes, while suppressing indicators to the device owner of this use.

SIM to UE (S2U) Attacks. The S2U adversary model may involve the supply-chain insertion of logic within the SIM to proactively initiate outbound SMS messages without the consent or awareness of the UE owner. One functional legacy of SIM architectures prior to the development of smartphones was an extension of the SIM from an identity management unit to a computing platform capable of independently executing embedded applications, including an entire SIM-local browser. For example, mobile operators may install their customers' SIMs with applications that can access and exfiltrate sensitive UE-local data back to the mobile core using the SMS cellular service. Such SIM functions may be called exfiltration because these operations often occur without the user's consent or awareness, and thus may be potentially exploited by supply-chain attackers.

### Example SMS Attacks Targeting UEs

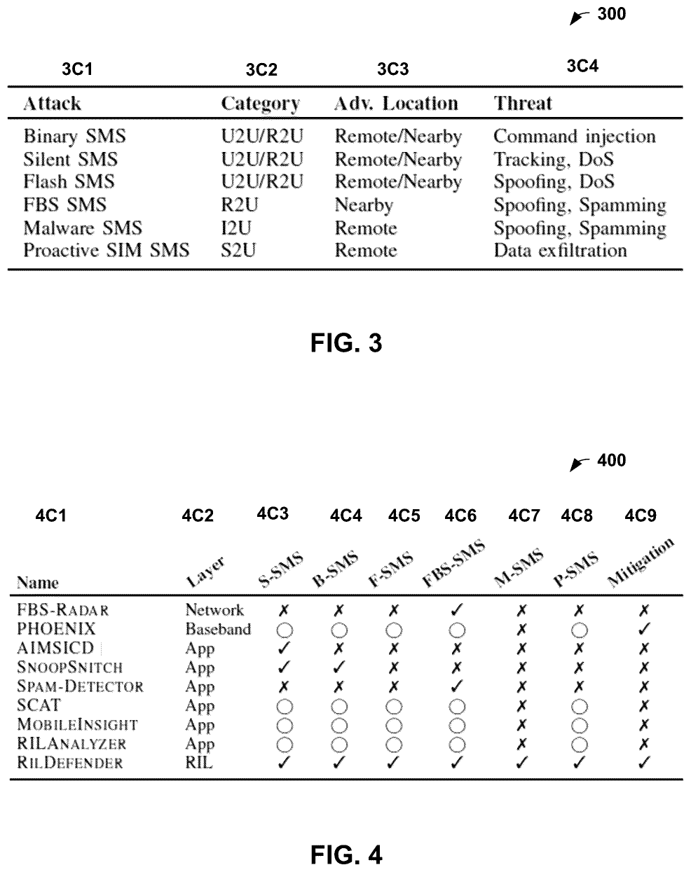

FIG. 3 displays a table 300 listing example SMS attacks targeting user devices, in accordance with example embodiments. The SMS attacks targeting user devices may be broadly classified into six categories as summarized in FIG. 3 and described below. First column 3C1 lists a type of attack, second column 3C2 lists a corresponding category or categories associated with the attack in first column 3C1. Third column 3C3 lists a location for the attack, and fourth column 3C4 lists a type of threat or potential activity.

Binary SMS. One example type of SMS is a binary SMS whereby the user data field carries binary data or executable code. These messages were originally designed for tasks such as over-the-air (OTA) SIM updates, voice mail notifications, and device configuration. However, this feature has been demonstrated to present an attack vector in prior exploits such as WIBAttack and Simjacker. These exploits allow remote attackers to use a binary SMS to inject surreptitious code logic in victim devices without the knowledge or consent of the UE owner. Example functionality enabled may include dialing a specified number, sending an SMS, launching a browser with a specified URL, and/or acquiring the victim's location without permission. Such functions may be processed by the SIM, thereby bypassing application OS-level notifications. Generally speaking, such exploits are feasible due to insufficient access controls within browser applications installed on SIM cards.

There may be three prerequisites for binary SMS attacks: (1) a victim UE that has installed a vulnerable SIM, (2) an SMSC that does not filter binary SMS messages, and (3) an attacker who can craft and send a malicious binary SMS payload in Protocol Data Unit (PDU) mode. It is known that a large portion of SIMs produced in many countries may be vulnerable to Simjacker. In addition, defending, preventing, and/or mitigating against such an attack may involve a coordinated effort across operators to defend against binary SMS attacks because attackers can arbitrarily specify the SMSC address in the SMS payload. As a result, it may be challenging to prevent binary SMS attacks within the existing cellular network ecosystem.

Silent SMS. Another example type of SMS silently handled by UEs is called silent SMS or type zero SMS. For example, upon receiving a silent SMS, a UE may typically respond with a delivery report for acknowledgment. The baseband, SIM, and RIL may handle this SMS, without involvement from user-space applications. Thus, the UE owner may be completely unaware that a silent SMS message has been delivered. In some aspects, law enforcement may use a silent SMS (in some countries) to track individuals through their mobile phones, since a silent SMS forces the UE to respond with a delivery report back to the sender. The response SMS may be used to perform distance measurements and triangulation to infer the owner's approximate geolocation. In addition, silent SMS may be exploited for malicious purposes, such as conducting denial-of-service (DOS) attacks via silent SMS flooding, and/or extracting a user's Temporary Mobile Subscriber Identity (TMSI) over the air.

Flash SMS. Flash SMS may also be referred to as class 0 SMS. A flash SMS received by a UE may be displayed on the device display screen through a pop-up window and may be deleted once the window is dismissed. As a result, flash SMS may be used to push alerts and notifications to users (e.g., weather alerts, etc.). However, a flash SMS may also be exploited by malicious attackers to crash smartphones. Attackers may also design a malicious flash SMS with fake alerts to spoof users, as its sender information is not generally shown. Similar to binary and silent SMS, the attacker requires only a USB modem to inject flash SMS messages to remote target UEs.

Fake Base Station SMS. It has been shown that GSM (i.e., 2G) fake base stations (FBS) hosted on SDRs by an attacker may send fraud and spam SMS to nearby users. For example, the attacker may impersonate a legitimate contact of the victim to send out a spoofed SMS to ask for money transfer. FBS SMS messages are prevalent in some countries. For example, in China, mobile users received more than 5.7 billion FBS messages in 2015. Establishing a fake base station is also feasible and profitable for an attacker. For example, an attacker may establish an FBS for as little as $700, while the exploits from the FBS may generate revenues of more than $1,400 a day.

Malware SMS. Although modern smartphones have deployed permission mechanisms for access control, malware remains a prevalent threat. For example, more than 10M devices were infected by a single malware in 2021. Malware links may often be spread over SMS or hidden in mobile app stores, and may lure users to install and grant privileges (e.g., by impersonating legitimate postal-service apps or COVID-19 notification apps). When permissions are granted, the remote attacker may use the malware to initiate calls and/or send SMS without the UE owner's awareness. Moreover, malware may not be dependent on SMS permission to abuse IMS-based SMS silently. Accordingly, the existing OS-level defense (e.g., permission scheme) is not sufficient against this malware.

Proactive SIM SMS. In some embodiments, program logic may be inserted into the supply chain of mobile SIMs, enabling them to transmit SMS messages to the mobile operator without the knowledge or consent of the UE owner. This type of SMS may be referred to as proactive SIM SMS that may be triggered by many of the existing SIMs in the market. Recently, AT&T SIMs were found to include embedded proactive logic to send SMS messages when the SIM detects hardware or firmware configuration changes. This discovery occurred as a result of a lawsuit involving a car accident. One of the involved drivers was accused of being distracted due to an SMS sent from the driver's smartphone at a time close to when the accident occurred. However, this SMS was found to have been sent from the AT&T SIM to an AT&T managed phone number dedicated to proactive SIM message collection. These SMS messages and AT&T's proactive logic are entirely undocumented, and the structure of these SMS payloads and the proactive generation logic remain undisclosed. While proactive SIM SMS may serve benign purposes, it may also be weaponized by supply-chain attackers to produce malicious SIMs to exfiltrate sensitive user data.

### Example Existing Defenses Against SMS Attacks

FIG. 4 displays a table 400 listing example existing defenses against SMS attacks targeting user devices, in accordance with example embodiments. The terms S-SMS, B-SMS, F-SMS, M-SMS, P-SMS respectively denote silent, binary, flash, malware, and proactive-SIM SMS. First column 4C1 lists a type of defense, second column 4C2 lists a corresponding layer (e.g., network, baseband, app, RIL). Third column 4C3 to eighth column 4C8 indicate whether the defense in implemented (e.g., a check), not implemented (e.g., a cross), or not implemented but potentially extensible (e.g., an empty circle “O”). The ninth column 4C9 indicates a mitigation status.

Network-based Defenses. One example defensive strategy may be to detect attacks at the radio access network by deploying cellular network monitors to collect a large amount of network traffic for analysis. One notable example of this approach is FBS-RADAR that detects fake base station SMS at scale based on crowdsourced data collected from mobile users. The detection algorithm depends on a series of network heuristics including unusual signal strength, invalid BS broadcast parameters, incorrect geolocation, and/or fraudulent SMS content. However, network-based defenses may be weakened due to coverage issues as numerous network monitoring hardware systems must be deployed, making coverage difficult to be achievable in practice.

UE-centric Defenses. UE-centric defenses may be deployed directly on UE devices to defend against the threats locally. Compared to network-based defenses, UE-centric defenses may be low-cost and easier to deploy as they are not dependent on additional hardware; and an installation of a smartphone app or an updated system firmware may be needed. Such defenses also generally have an acceptable overhead on UEs. As summarized in FIG. 4, there are seven UE-centric defenses (except FBS-RADAR), which may be deployed on the Android platform. From a deployment perspective, such a defense may be at the baseband or the app layer, as described below.

Baseband-layer Defenses. Ideally, baseband-layer defenses are at a processing layer that may prevent cellular attacks targeting the UE, as the baseband provides visibility and control over low-level cellular network traffic. Unfortunately, it may be challenging for an unauthorized party to deploy baseband-layer defenses (e.g., using binary hardening) as the baseband is closed-source and often protected by tamper-resistance signature verification, thereby preventing unauthorized modifications. Some baseband vendors appear to have deployed defenses such as FBS detection. However, such approaches fail to comprehensively address the SMS threats, and the details are not publicly disclosed. For example, while not focusing on SMS attacks, PHOENIX provides both detection and mitigation for a series of cellular control-plane attacks. It retrofits the cellular stack of an open-source UE, such as srsLTE, which is equivalent to baseband modification. However, due to design constraints, such a design is difficult for an unauthorized party to achieve in practice. Moreover, such a design does not generalize well due to highly-diversified baseband implementations across vendors.

App-layer Defenses. Compared to baseband-layer defenses, app-layer defenses may be easier to deploy for end users. Among the defenses listed in FIG. 4, three defenses support SMS attack detection, including silent SMS (e.g., Android-IMSI-Catcher-Detector (AIMSICD), SNOOPSNITCH®), binary SMS (e.g., SnoopSnitch), and FBS SMS (e.g., Spam-Detector). Two defenses (e.g., Signaling Collection and Analysis Tool (SCAT), MOBILEINSIGHT™) are designed for network traffic monitoring and diagnosis in UEs. In summary, these defenses mainly rely on reading low-level cellular traffic from the baseband chips or using high-level Android APIs to sense the cellular network parameters (e.g., signal strengths of nearby base stations). Notably, RILAnalyzer is also an app layer defense that monitors 3G traffic from baseband logs, and thus is fundamentally different from RILDEFENDER, as described herein.

Modern smartphone OSs have deployed defenses such as SMS permissions and spam SMS filters. While these may be useful to mitigate some SMS threats, they are not sufficient against more sophisticated SMS attacks such as silent and binary SMS. Moreover, though the permission scheme restricts access to critical resources and functions, it cannot eliminate the malware SMS threat, and a second line of defense is needed when the permission access control is bypassed.

### Example Design of RILDEFENDER

RILDEFENDER is an inline prevention system deployed at the Radio Interface Layer (RIL). RILDEFENDER is designed to balance the benefits of monitoring at the upper application layer and bottom baseband layer, which translates to a trade-off between deployability and visibility. Generally speaking, RILDEFENDER is a software-implemented defense, prevention, and/or mitigation protocol that is integrated into the UE operating system, and may be deployed via OS upgrades. Note that such upgrades may be issued directly from OS manufacturers, such as GOOGLER. In addition, professional users may be able to integrate RILDEFENDER into the UE's firmware image and flash it into the UE using available tools such as FASTBOOT.

### Example Distinctions of RILDEFENDER Over Existing Defenses

In some aspects, RILDEFENDER may include some distinctions over the existing afore-mentioned UE-centric defenses.

Inline Control. RILDEFENDER may be configured to detect a wide range of SMS attacks, and may also provide inline control to automatically block the attacks by manipulating corresponding internal-control logic. Existing defenses described in FIG. 4 provide after-the-fact detection, and are not configured to block the attacks. One notable exception is PHOENIX″, which is a baseband-level defense. However, as previously described, PHOENIX® is deployed at srsLTE and is not designed to target UEs in practice. Such inline control capability in RILDEFENDER is significantly valuable as it enables real-time mitigation of threats as and when the attacks occur.

Generality. As RIL is vendor-agnostic and generally applicable to the OS of Android UEs, RILDEFENDER can be deployed in smartphone UEs without much vendor-specific modification that may result in additional costs and complexity. One example vendor-dependent component may be an optional baseband monitor integrated to address non-interactive binary SMS attacks. In contrast, existing UE-centric defenses rely on parsing vendor-specific baseband traffic.

Extensibility. RILDEFENDER may be extended with new SMS attack signatures and mitigation policies, that may be modeled as propositional logic encoded by various programmable languages (e.g., YAML Ain′t Markup Language (YAML), JavaScript Object Notation (JSON), etc.). Also, for example, new extensions (e.g., signatures and policies) may be integrated through an RILDEFENDER app by the users without redeploying RILDEFENDER at the OS layer. By contrast, existing defenses are mostly static and cannot be easily extended for new attacks.

### Challenges and Solutions

Detecting Baseband-only SMS Attacks. RIL-based defenses generally do not have complete visibility to low-level cellular information. For example, some instances of binary SMS may be directly handled within the baseband without being passed to the RIL. To detect these baseband-only SMS attacks, a Baseband Monitor component may be integrated in RILDEFENDER. The Baseband Monitor may be configured to establish a communication channel with the baseband processor (BP) through a diagnostic interface to parse baseband traffic and detect the SMS events of interest. Note that the diagnostic interface (e.g., /dev/diag in QUALCOMM® devices) is prevalent among heterogeneous ANDROID and iOS® devices. Publicly available libraries support baseband monitoring of major vendors (e.g., QUALCOMM®, SAMSUNG, and MEDIATEK®), which serve as the building blocks to develop a baseband monitor component.

Tracking SMS Context. Generally speaking, relying on the structural information of an SMS (i.e., the SMS fields described in FIG. 1B) may not be sufficient to detect some SMS attacks. For instance, for a message with an outbound SMS payload only, RILDEFENDER may be unable to determine if the message is triggered by a legitimate user, a proactive SIM, and/or a malicious application, to determine the presence of a malicious outbound SMS attempt. Similarly, to detect an FBS SMS, data related to signal strengths and parameters broadcast from the connected BS when the SMS is received may be needed. Accordingly, RILDEFENDER may generally depend on the context data when an SMS is captured at the RIL. To address this challenge, some embodiments may include identifying a source of an outbound SMS based on inter-process communication calls to a user-space application. For example, a Context Extractor component may be designed to track the SMS context (e.g., the originating source and connected BS states). As a system-layer defense, RILDEFENDER can identify the source of an outbound SMS by making inter-process communication calls to the user-space applications. This feature is a significant advantage of RILDEFENDER as a system-level deployment feature, and cannot be achieved by the app-layer defenses.

### RILDEFENDER at the Radio Interface Layer

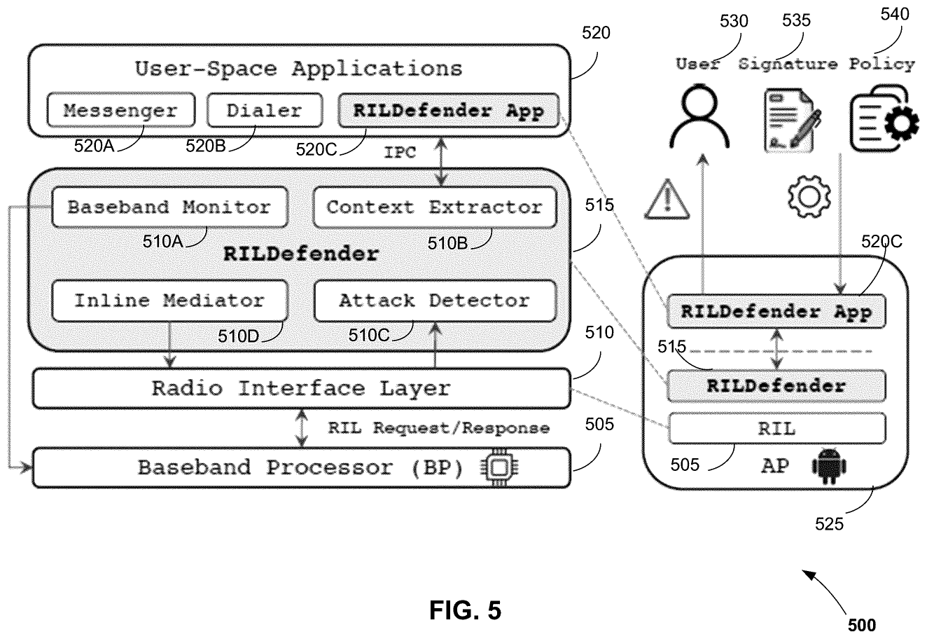

FIG. 5 illustrates an architecture 500 of RILDEFENDER deployed at a RIL and an application layer, in accordance with example embodiments. For example, RILDEFENDER 515 may be deployed at RIL 510 and app layer 525. As previously described with respect to FIGS. 2A and 2B, a baseband processor (or cellular processor) 505 may communicate via RIL 510 (e.g., using RIL Request/Response protocols). The RILDEFENDER app 520C may be deployed in user-space applications 520 and app layer 525. App layer 520 may also include messenger 520A, dialer 520B, and other applications. User 530 may be associated with signature 535 and policy 540.

In some embodiments, RILDEFENDER 515 at the RIL 510, may include one or more logical components such as baseband monitor 510A, context extractor 510B, attack detector 510C, and inline mediator 510D.

Some embodiments may include monitoring baseband traffic from a proprietary protocol based on the diagnostic interface. For example, Baseband Monitor 510A may be based on existing libraries to monitor and interpret baseband traffic from proprietary protocols through the diagnostic interface. In some embodiments, the detecting of the potential activity includes detecting a baseband-only malicious attack. For example, existing library implementation may be tailored to only extract the SMS traffic of interest (to detect baseband-only SMS attacks).

Some embodiments may include interacting with one or more user-space applications to track a context associated with the SMS interaction. For example, Context Extractor 510B may interact with user-space applications 520 to track the SMS context (e.g., the process that initiates an outbound SMS). Some embodiments may include retrieving the context data from a system layer. The context data may be associated with a broadcast station. The context data may relate to one or more of a signal strength or a broadcast parameter. For example, context extractor 510B may record additional context data from the system layer such as the signal strength and broadcast parameters from the connected base station.

Attack Detector 510C may instrument the internal RIL logic to detect SMS attacks. To comprehensively cover inbound and outbound SMS, the detection logic may be located within the RIL handler (e.g., RIL.java) that processes RIL requests and responses from an architectural point of view. To detect SMS attacks, attack detector 510C may acquire the SMS payloads from the RIL traffic and gather information from the baseband monitor 510A and context extractor 510B to perform analysis against the criteria defined within its attack signature set (e.g., signature 535).

Inline Mediator 510D may instrument the RIL logic and interact with the RIL 510 to provide inline control to mitigate detected SMS attacks. Each RILDEFENDER policy (e.g., policy 540) may be individually configurable by the user 530 to produce alerts only, or to additionally perform inline mitigation of the detected malicious SMS event.

### RILDEFENDER at the Application Layer

RILDEFENDER 515 may also include a user interface app, RILDEFENDER App 520C at the application layer 520, which displays alerts and allows user 530 to configure operating parameters and load custom attack signatures 535. Some embodiments include providing an indication of the potential activity.

Real-time SMS Attack Alert. When an SMS attack is detected by RILDEFENDER 515, and the user 530 indicates approval to receive real-time alerts, a broadcast intent may be generated along with the attack event details (e.g., the SMS source, destination, and payload). The broadcast intent may be asynchronously delivered to the RILDEFENDER app 520C, which may be configured to display the alert using a notification center to indicate the event details.

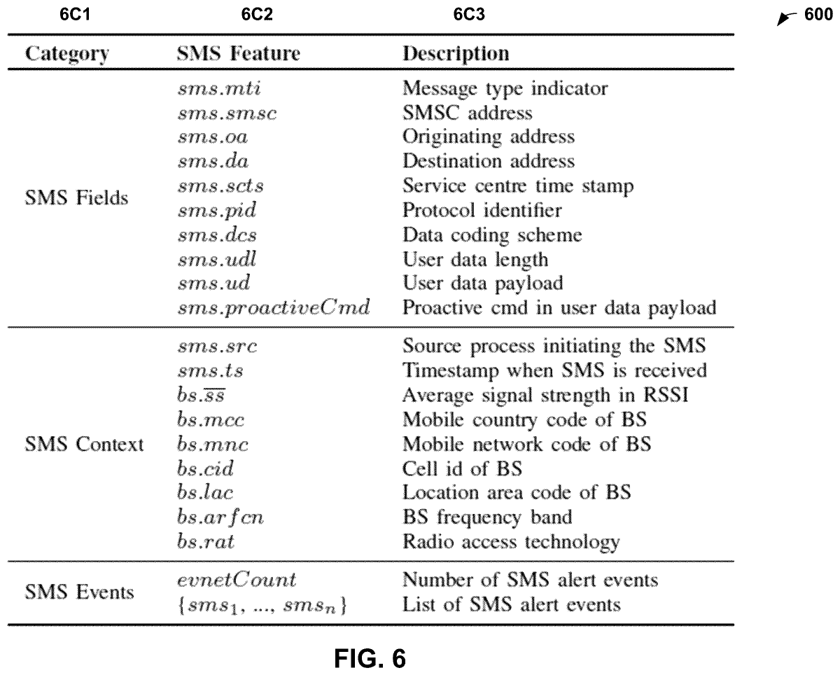

Extensible Attack Signature. In some embodiments, RILDEFENDER 515 may use propositional logic to describe SMS attack signatures 535. To support extensible attack signature design, RILDEFENDER 515 may be configured to collect a wide range of SMS features listed in table 600 of FIG. 6.

FIG. 6 displays a table 600 listing example SMS features collected at a radio interface layer, in accordance with example embodiments. First column 6C1 lists a category (e.g., SMS fields, SMS context, SMS events), second column 6C2 lists the corresponding SMS features, and third column 6C3 provides a description of the SMS feature.

SMS Fields. The SMS fields may be extracted from the payload structure described with reference to FIG. 1B. For example, an SMS's PID and DCS may be denoted by sms.pid and sms.dcs, respectively.

SMS Context. The SMS context indicates the context information when an SMS is sent or received. For an outbound SMS message, the originating process that initiated the SMS may be tracked (denoted by sms.src) through IPC calls. RILDEFENDER 515 may also record the attributes of the currently connected BS (denoted by bs), such as an average signal strength (bs.ss), cell id (bs.cid), and frequency band (bs.arfcn).

SMS Events. The past SMS events may be tracked in a list {sms1, . . . , smsn} in temporal order, and each event may include the corresponding SMS fields and context. Although the detection of the different types of SMS attacks may not depend on n these features, RILDEFENDER 515 may support them for future attacks that may be based on a reasoning of temporal SMS events.

To make the SMS attack signatures 535 configurable for end-users, RILDEFENDER 515 may encode signatures 535 with programmable language, such as YAML, JSON, etc. For example, YAML is a human-readable language to express structural data, and has been widely adopted in many platforms to describe network policies and configurations.

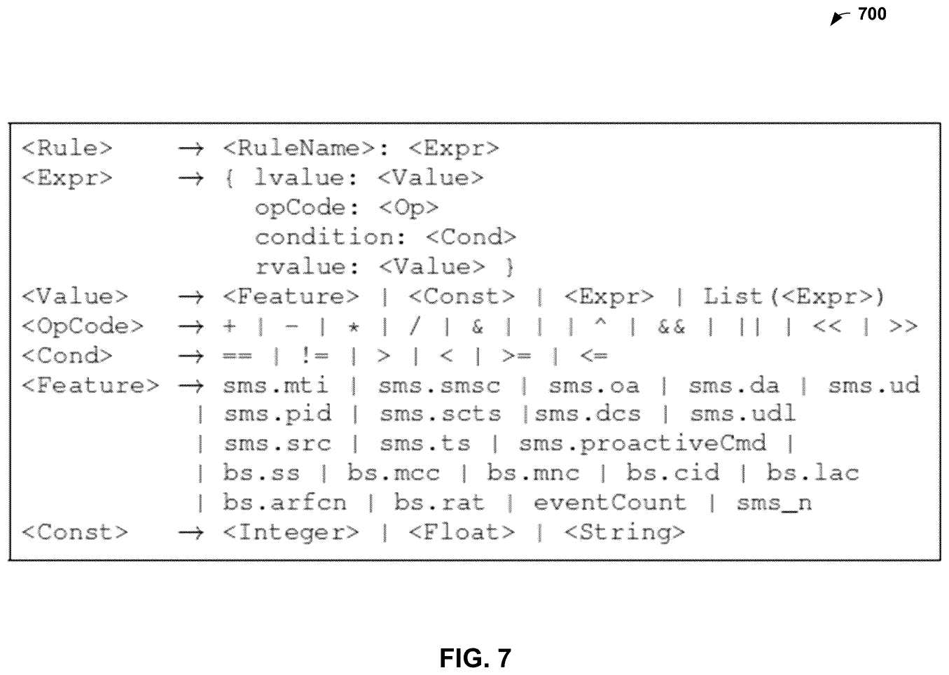

FIG. 7 displays high-level examples 700 of propositional logic-based SMS attack signatures, in accordance with example embodiments. For example, a high-level representation of YAML encoded signatures are illustrated. To add a custom attack signature, the user may configure a few attributes. As in the example, “lvalue” defines the left operands in the signature, which may use the SMS features defined in second column 6C2 of table 600 of FIG. 6. Also, for example, “opcode” and “condition” define the computation (e.g., arithmetic and logical) and rational operators, respectively, and “rvalue” indicates the right operand.

Flexible Mitigation Policy. Referring again to FIG. 5, the mitigation policies may be configured by user 530 upon attack signatures 535 with four different types: Allow, Notify, Block without Notify, and Block and Notify, which represent different levels of mitigation of a specific attack.

### Example RIL Design

In some embodiments, a user interface may be developed as a system app integrated in the AOSP system image. The front end of RILDEFENDER app may be mainly dedicated to policy configurations, browsing past SMS alert events, and configuring SMS whitelist. Users may interact with the app to configure the mitigation policies for each SMS attack. For instance, the user may choose to receive notifications for silent SMS while blocking all incoming binary SMS. The notification service may run as a background process and continue to monitor the RIL and baseband monitor events for the occurrence of attacks. Such operations are shown to consume very little resource for the overall system.

New, extensible YAML attack signatures may be designed for new SMS attacks, and the signatures may be converted into corresponding logic at the RIL. In addition to the six types of SMS attacks in table 300 of FIG. 3, RILDEFENDER may be extended with new attack signatures by utilizing the SMS features in table 600 of FIG. 6. For instance, a user may automatically block SMS from a certain user by setting up a signature using the SMS destination (sms.da) from the feature list. The user may also prevent silent SMS DOS attacks by using temporal SMS events in the past. When new attack signatures are configured, they may be broadcast to the system layer of RILDEFENDER and stored in persistent memory. Once there is an SMS event, RILDEFENDER may iterate the stored SMS detection rules to match the event against them. For each of the rules, RILDEFENDER may be configured to include a YAML signature parser that automatically converts the human-written rules into corresponding program logic, which is computed based on the SMS event features. Finally, the parser can output Boolean values to indicate the matched rules for the SMS event.

As described herein, RILDEFENDER may integrate a baseband monitor to capture non-interactive binary SMS attacks as they are not visible to the RIL. Although for implementation purposes, the supportive libraries from SNOOPSNITCH may be used as building blocks to realize the baseband monitor (BM), alternative libraries may also be used such as the libraries from SCAT and MOBILEINSIGHT, which provide a wide range of support for different baseband chipsets. However, as the BM needs to constantly poll the baseband for its traffic, there may be additional overhead to the overall power consumption.

To minimize such overhead, the implementation of RILDEFENDER may be tailored to the BM component to reserve only the logic for non-interactive binary SMS detection. Additionally, RILDEFENDER can provide flexible configurations to adjust the baseband traffic polling frequency, and the user may have an ability to disable the BM component if non-interactive binary SMS detection is not necessary. This may significantly reduce the power consumption as well. While reducing the baseband traffic polling frequency may reduce power consumption, this may add to the delay of the attack notification. Results indicate that adding a 1-second delay to the BM component can save 2%-3% of battery consumption for 5 hours.

SMS Workflow within the Radio Interface Layer

The internal workflow of the RIL may be described with a particular focus on how SMS (inbound and outbound) is handled. In particular, RIL is used in Android for all the illustrations.

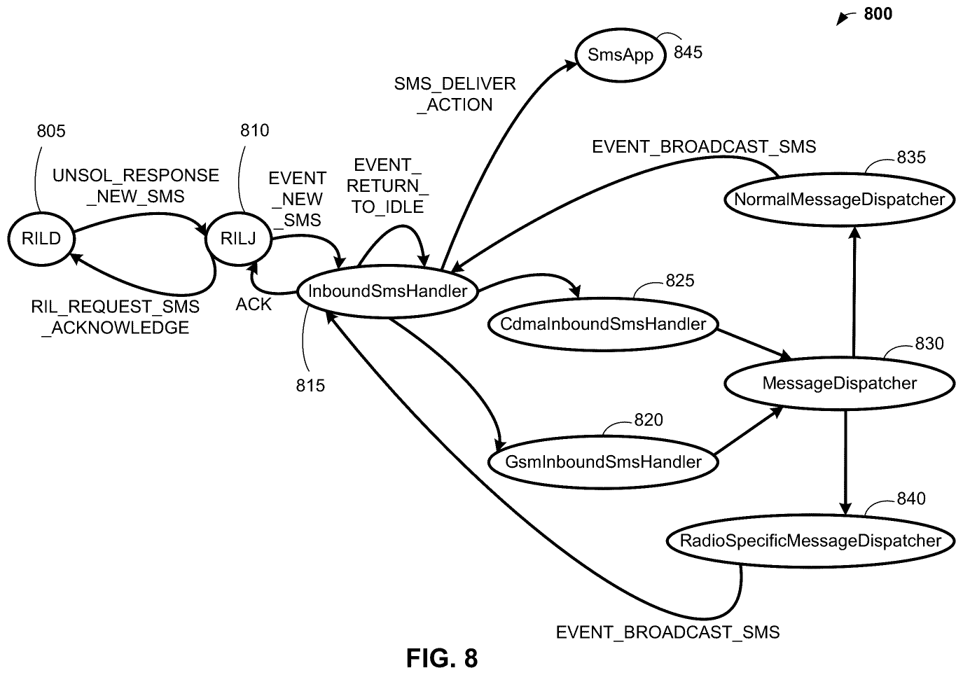

FIG. 8 illustrates an abstract workflow 800 for inbound SMS processing at the RIL, in accordance with example embodiments. When an SMS arrives at the UE, it is delivered from the baseband to the RILD 805 and handled by the RILJ 810 as well as InboundSmsHandler 815 sequentially. Next, based on UE type, the RIL selectively invokes GsmInboundSmsHandler 820 or CdmaInboundSmsHandler 825 to process the SMS message, and the handler logic relies on a MessageDispatcher 830 component. After parsing the PDU bytes of the SMS, different dispatchers may be called for the SMS. For normal text SMS, the RIL uses NormalMessageDispatcher 835. For special types of SMS including silent, flash, and binary SMS described herein, the RIL calls RadioSpecificMessageDispatcher 840. When the dispatcher finishes, the control is back to the InboundSmsHandler 815, which broadcasts the SMS to the SMS app 845 at the application layer. The workflow 800 shows that the RIL has corresponding processing logic for different types of SMS, which allows the RILDEFENDER to detect and block the SMS attacks.

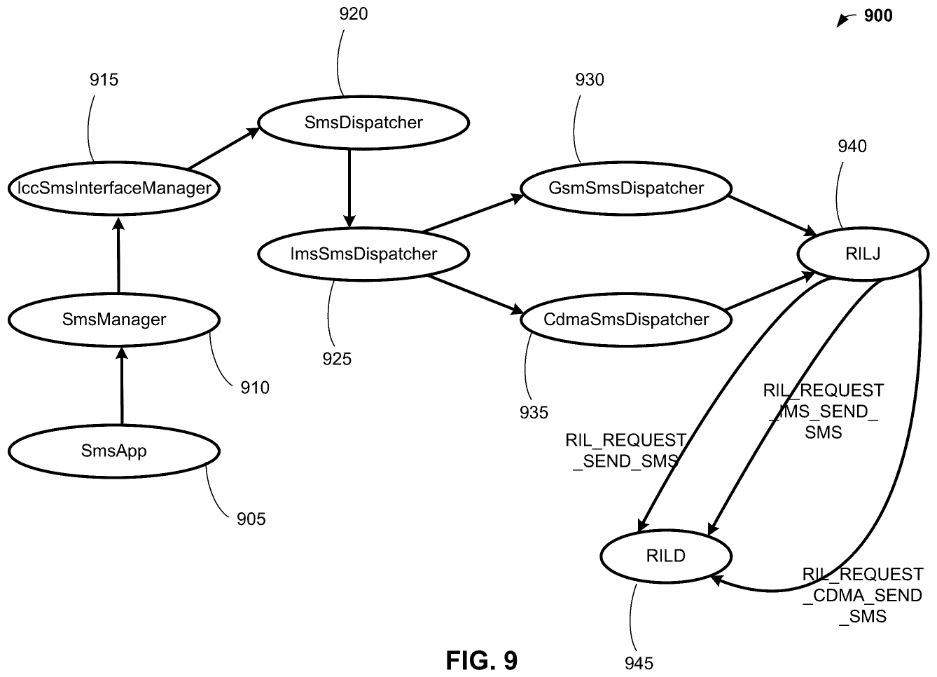

FIG. 9 illustrates an abstract workflow 900 for outbound SMS processing at the RIL, in accordance with example embodiments. An SMS may be initiated at the SmsApp 905 and SmsManager 910 may provide it to IccSmsInterfaceManager 915. RIL may use different dispatchers to handle outbound SMS. For example SmsDispatcher 920 may receive the SMS and send it to ImsSmsDispatcher 925, which then relays it to GsmSmsDispatcher 930, and CdmaSmsDispatcher 935. There are three different RIL commands corresponding to different SMS types, which allows the RIL to inform the baseband to send GSM, CDMA, or IMS SMS. The RILJ 940 handles the outgoing SMS and RILD 945 delivers it to the baseband for communication to the base station. Workflow 900 facilitates an intent-aware detection approach, as the RIL has a direct communication path with the SMS app 905 at the application layer, allowing implementation of an intent detector to monitor the apps at the upper layer.

Based on the above illustrations, both inbound and outbound IMS-based SMS are handled within the RIL. Accordingly, the internal RIL traffic may be dynamically analyzed on the tested Android devices (both being installed with official factory images that support IMS SMS). In some embodiments, inbound IMS SMS is handled by the GsmSmsInboundSmsHandler that is configured with a traditional SMS handling logic. An outbound SMS is sent by using a RIL_REQUEST_IMS_SEND_SMS request to the baseband. In conclusion, both the inbound and outbound IMS SMS logic is visible to the RIL, and RILDEFENDER can be extended to support IMS SMS as well, thereby covering 4G and 5G networks.

### SMS Payload Tested

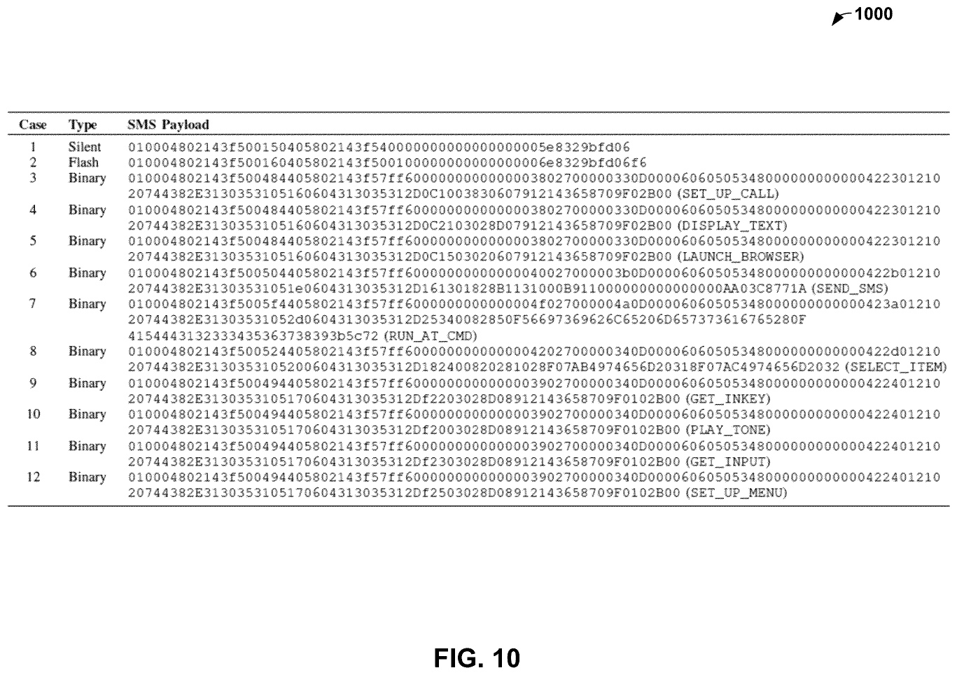

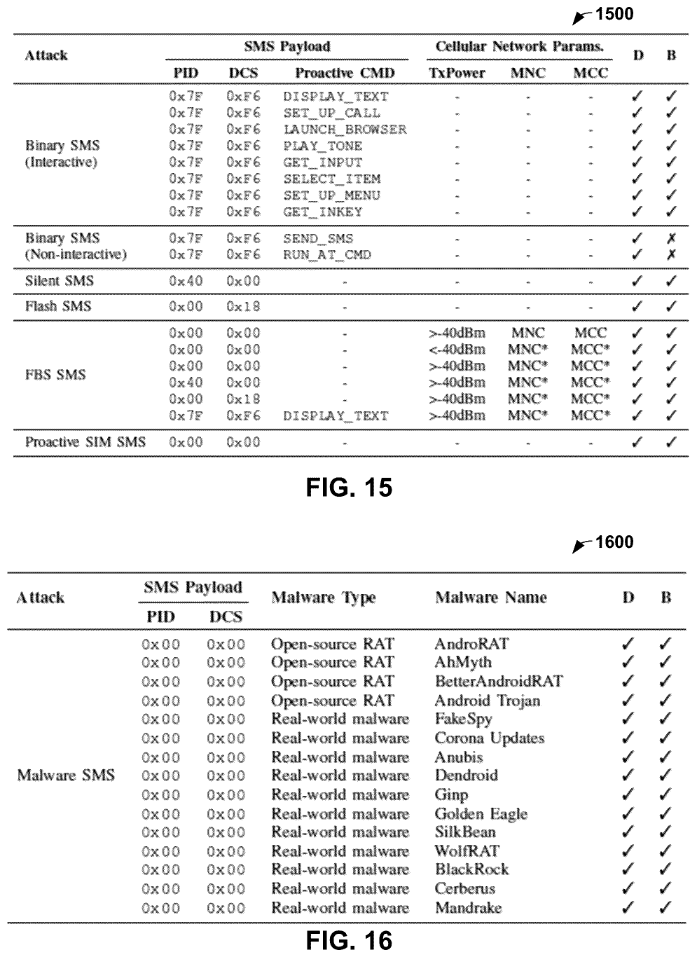

FIG. 10 displays a table 1000 illustrating raw Protocol Data Unit (PDU) payload for example SMS test cases, in accordance with example embodiments. For example, table 1000 displays the raw PDU payload of the SMS test cases illustrated in tables 1500 and 1600 of FIGS. 15 and 16, respectively. These SMS payloads are of SMS-Deliver types as they are transmitted from the experimental SDR (equivalent to an SMSC) to the tested devices. The destinations of the SMS payloads have been anonymized to zero values. As shown in table 1000, three types of SMS including silent SMS, flash SMS, and binary SMS are tested. For the binary SMS, variant attack payloads based on the proactive commands are shown. For instance, 0x13 and 0x34 are the proactive commands for SEND_SMS and RUN_AT_CMD, respectively. For the remaining types in table 1000, FBS SMS messages have as identical payload as the aforementioned SMS types. Malware and proactive SIM SMS are outbound SMS triggered by an application or the SIM, and thus their contents vary based on the SIM and application logic.

### Example Implementations

In some embodiments, RILDEFENDER may be configured atop an Android Open Source Project (AOSP). In some embodiments, the baseband log monitor may be implemented using the libraries from SNOOPSNITCH for QUALCOMM® baseband. Also, for example, RILDEFENDER may be extended for non-AOSP devices due to the generality of the RIL. As described below, RILDEFENDER may be implemented to detect and mitigate a spectrum of SMS attacks described in table 300 of FIG. 3.

### Binary SMS

When a binary SMS is sent to a mobile device (or UE), the baseband may parse the SMS payload and determine its type. If it is a binary SMS, the baseband relays the SMS to the SIM for further processing. Binary SMS may include a series of proactive Universal Integrated Circuit Card (UICC) commands in the user data field, which may be processed by the embedded applications in the SIM, such as the S@T browser and the Wireless Internet Browser (WIB). When the SIM's internal browser is configured with the least security protection, it is likely to blindly instruct the application processor to execute the proactive UICC commands contained in the binary SMS. This may be applicable to Simjacker and WIBAttack. There are other types of binary SMS targeting the UE OS, such as WBXML SMS for MMS/APN configurations, which may be exploited to trigger an integer overflow bug (e.g., in SAMSUNG GALAXY® devices). Such binary SMS may be handled similarly with other binary SMS attacks.

In some embodiments, a binary SMS may be classified as an interactive binary SMS, which when received will initiate user engagement to process the message, or non-interactive binary SMS. Correspondingly, RILDEFENDER may employ different attack signatures to handle each type of binary SMS.

Interactive Binary SMS. This type of binary SMS may invoke interactive functions by transmitting a UICC proactive command to the RIL, such as SET_UP CALL, LAUNCH_BROWSER, DISPLAY_TEXT, and PLAY_TONE. For instance, a binary SMS with LAUNCH_BROWSER may spawn the Internet browser with a specified URL embedded as an SMS parameter. An interactive binary SMS is based on user interaction, and is therefore delivered to the application layer to trigger corresponding user-interactive operations.

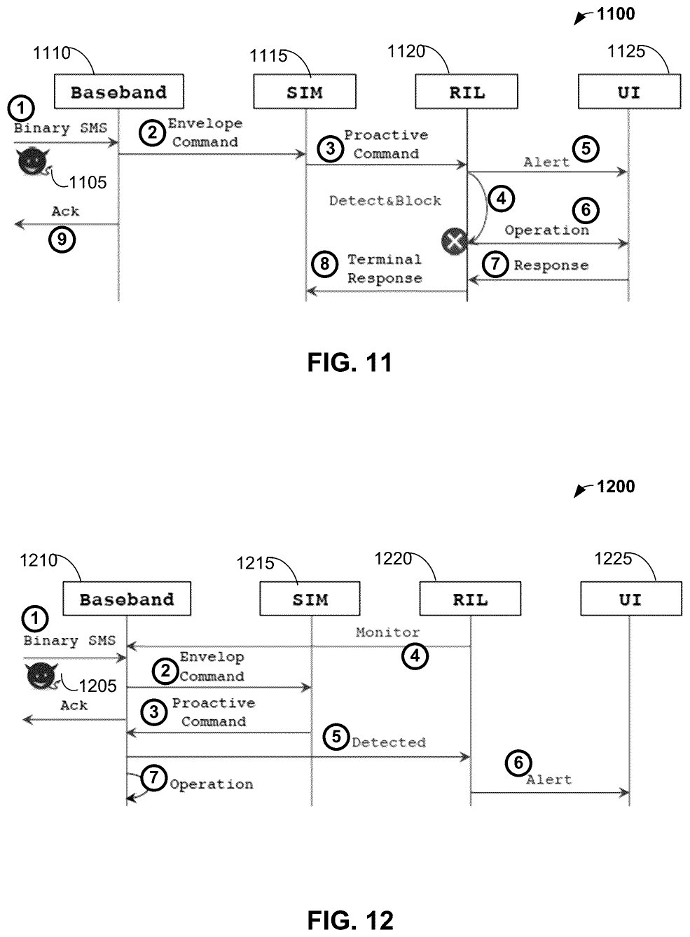

FIG. 11 is an example high-level workflow 1100 of an interactive binary SMS attack, in accordance with example embodiments. At step 1, the binary SMS 1105 may arrive at the UE. At step 2, the baseband 1110 may convert it into an envelope command and relay it to the SIM 1115. At step 3, the SIM 1115 interprets the envelope command and instructs the AP to execute the specified function with a proactive UICC command. Next, the RIL 1120 is notified of the proactive command (e.g., through an unsolicited RIL command UNSOL_STK_PROACTIVE_COMMAND), and at RIL 1120 may handle it with a Card Application Toolkit (CAT) service handler. At step 5, RIL 1120 may generate an alert to be delivered to UI 1125. Based on the command type, at step 6, the RIL 1120 may further invoke the corresponding UI 1125 operation at the application layer. At step 7, UI 1125 may send a response to RIL 1120, and at step 8, a terminal response may sent back to the SIM 1115. Based on the distinct behavioral signature, RILDEFENDER may use the following detection rule:

$$( sms . proactiveCmd ) \neq ∅ ) \to S M S ( Binary , Interactive )$$

where RILDEFENDER may detect an interactive binary SMS when the RIL 1120 is notified for a proactive command from the SIM 1115. To mitigate the SMS, at step 4, the inline mediator may be configured to intercept the proactive command at the RIL 1120 and block the proactive commands from being executed at the application layer.

In some embodiments, for some executed commands, SIM 1115 may not transmit the command to the RIL 1120, and instead may directly instruct the baseband 1110 to initiate a voice call. For example, the proactive command SET_UP_CALL exhibits such behavior. Next, the RIL 1120 may be notified for an initiated outgoing voice call (e.g., by an unsolicited message CALL_STATE_CHANGED), and further spawns a voice call dialog at the dialer app. To detect this attack, RILDEFENDER needs to correctly detect if the voice call is triggered by a binary SMS rather than a normal user operation, which ensures benign operations are not mistakenly blocked. As a result, RILDEFENDER may use an intent-aware detection to monitor the user intent from the application layer context. When the attack is detected, RILDEFENDER may suspend the voice call by sending a solicited RIL command HANGUP to the baseband 1110.

Non-interactive Binary SMS. For non-interactive binary SMS, some proactive command types such as SEND_SMS and RUN_AT_CMD, may be used. These commands instruct the UE to send out an SMS and run AT commands, respectively. In general, there may be additional non-interactive proactive commands, such as PROVIDE_LOCAL_INFO, which can fetch the UE's information including location, IMEI, IMSI, and so on. However, they need to be chained with the previous commands such as SEND_SMS to achieve certain attack goals (e.g., leaking the victim's IMEI through SMS).

FIG. 12 is an example high-level workflow 1200 of a non-interactive binary SMS attack, in accordance with example embodiments. Compared with the interactive binary SMS described with reference to FIG. 11, detecting a non-interactive binary SMS attack may be more challenging as the proactive command from the SIM 1215 is likely to be relayed to the baseband 1210 instead of the RIL 1220. Fundamentally, this is because no user interaction is needed for the operation, and thus the event is not transmitted to the app layer, making it non-observable at the RIL 1220.

At step 1, the binary SMS 1205 may arrive at the UE. At step 2, the baseband 1210 may convert it into an envelope command and relay it to the SIM 1215. At step 3, the SIM 1215 interprets the envelope command and instructs the baseband 1210 to execute the specified function with a proactive UICC command. The RIL 1220 is not notified of the proactive command. Therefore, RILDEFENDER utilizes the SMS traffic from the baseband monitor for detection of such threats.

For example, a binary SMS has distinct structural features, as it needs to have a PID field to be 0x7F (indicating USIM data download), and the DCS field to indicate a class-2 message. Based on this insight, RILDEFENDER may adopt the following attack signature:

$$( sms . pid = 0 \times 7 F ) ⋀ ( sms . dcs \& 0 \times 3 = 2 ) ⋀ ( sms . proactiveCmd ∈ \{ SEND\_SMS , RUN\_AT \_CMD \} ) \to S M S ( Binary , NonInteractive )$$

Based on the signature, at step 4, RILDEFENDER can parse the SMS from the baseband monitor traffic and synthesize the structural information of the SMS payload to detect the attack at step 5. After detection, the ideal mitigation may be to instruct the baseband 1210 to prevent the outcome of the message (e.g., stop the outbound SMS event). Unfortunately, having complete inline control over the baseband 1210 may not be feasible from the AP's perspective. Accordingly, at step 6, RILDEFENDER may utilize the alert mechanism to inform the user about the concrete threat via UI 1225. To achieve this, RILDEFENDER may further analyze the proactive commands and parameters from the SMS payload and generate an alert to the RILDEFENDER app in UI 1225. For example, for a SEND_SMS command, the user may be notified about the destination and content of the SMS sent. As another example, for a RUN_AT_CMD massage, the user may be notified about the specific AT command executed. Baseband 1210 may then perform appropriate operations at step 7.

### Silent and Flash SMS

Silent and flash SMS may be detected using similar signatures. Silent SMS and flash SMS may be handled by the RIL, making both detection and mitigation possible. In particular, for a silent SMS, the RIL may instruct the baseband to send a delivery report. For a flash SMS, the RIL may inform the upper system UI to display the message on the screen. The detection of these two SMS messages can be relatively straightforward, as they all have distinct structural signatures based on the 3GPP specification. For example, when an SMS arrives, RILDEFENDER may detect the presence of a silent SMS based on the following rule:

$$( sms . pid = 0 \times 40 ) \to S M S ( Silent )$$

in which RILDEFENDER dissects the SMS's PDU encoding to determine whether the PID filter equals 0x40. Similarly, RILDEFENDER may detect a flash SMS based on

$$( sms . dcs \& 0 \times 3 = 0 ) \to S M S ( Flash )$$

where RILDEFENDER may perform a bit-wise “and” operation on the DCS field to detect class 0 SMS. As a silent or flash SMS is detected at the RIL (e.g., by an SMS handler InBoundSmsHandler), RILDEFENDER can invoke the in-line mediator component to invoke the instrumented RIL logic to block further actions. In particular, RILDEFENDER can block the SMS by stopping the delivery report generation for a silent SMS, or by displaying the message to the user for a flash SMS.

### Fake Base Station SMS

A fake base station (FBS) SMS is generally sent from an adversary-controlled GSM base station to impersonate a legitimate source for spoofing and spamming purposes. In addition to known aspects of phishing, spoofing, and spamming attacks, FBS SMS can also be exploited by an attacker to send out a binary, silent, or flash SMS to attack a neighboring UE, thereby providing an alternative delivery vector for attack messages when SMS filters are deployed at some SMSCs.

Since an FBS SMS payload has the same structure as a benign SMS message and its source identity can be spoofed, it may not suffice to rely on structural signatures. Some existing approaches have demonstrated use of cellular state parameters (e.g., the broadcast parameters and signal strength of the connected base station) to estimate whether a UE is connecting with an FBS. Accordingly, the following heuristics-based detection rule may be incorporated:

$$( bs . \overline{ss} > - 40 dBm ) ⋁ ( Invalid ( bs . params ) ) \to S M S ( Fbs )$$

This rule analyzes the SMS context data from the currently connected BS. The average signal strength may be detected to be higher than an acceptable threshold strength. In some embodiments, a threshold strength of −40 dBm may be used to minimize a false positive rate. This threshold may be the approximate signal strength when a UE is placed right below a legal BS. Additionally, another rule may be adopted to check whether the broadcast parameters (summarized as bs.params) from the BS are syntactically invalid, or whether they do not match with the true location, which can be checked against a well-established syntax table. Although these parameters (e.g., MMC and MNC) could be manipulated by an FBS attacker, this rule is generally effective and can detect several FBSes in practice. In addition to text-based FBS SMS, RILDEFENDER can also block binary, silent, and flash SMS messages sent from an FBS. This is another significant improvement over existing approaches.

### Malware SMS

As previously described, relying on structural signatures may not be sufficient to detect SMS that are generated from malicious applications. In some embodiments, a source of an outbound SMS may be tracked from a context data to determine whether the SMS is triggered by the user's intention. RILDEFENDER uses a similar strategy to detect the binary SMS attack with SET_UP_CALL command. In the following, the intent-aware detection approach is described.

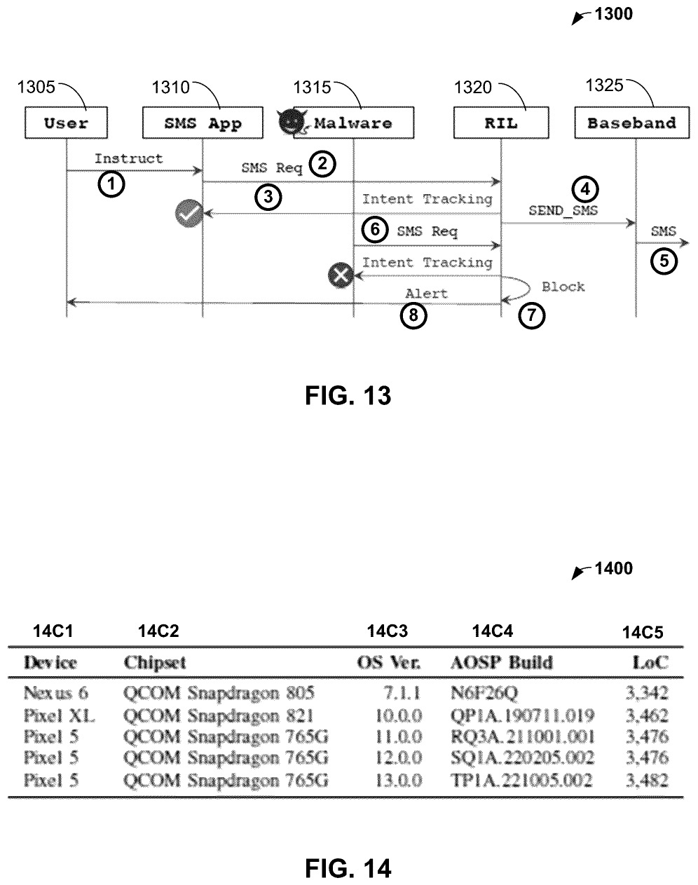

FIG. 13 illustrates an example detection and mitigation 1300 of malware SMS, in accordance with example embodiments. Application-layer programs interact with the RIL 1320 through inter-process communication (IPC), as they reside in different processes. At step 1, user 1305 may initiate an outbound SMS via SMS App 1310. At step 2, the SMS Request sent to RIL 1320 may be intercepted by RILDEFENDER. Accordingly, at step 3, RILDEFENDER may perform intent tracking to invoke system APIs (e.g., getCallingPid) to locate the source of the IPC call, and acquires the process initiating the IPC (denoted by sms.src). In the event the source is not from a trusted list (configurable through the RILDEFENDER app) In the event the source is from a trusted list (configurable through the RILDEFENDER app), at step 6, RIL 1320 may forward a SEND_SMS request to based band 1325, which may send the outbound SMS at step 5.

In the event the source is not from a trusted list (configurable through the RILDEFENDER app) such as malware 1315, RILDEFENDER may consider it suspicious and intercept the SMS intent from being passed to the baseband 1325, by blocking the SMS intent at step 7. At step 8, an alert may be generated by RIL 1320, and the alert may be provided to user 1305. Generally, RILDEFENDER may apply the following signature:

$$Suspicious ( ProcessOf ( sms . src ) ) \to S M S ( Malware )$$

This approach is similar to the detection of the SET_UP_CALL binary SMS attack, where the RILDEFENDER detects if the voice call originates from a trusted source (e.g., the default dialer app). One possible way to bypass this defense may be to spawn the default SMS app 1310 to send the SMS, as the SMS would normally be sent from a valid source. For instance, Android malware can submit an intent to invoke the UI of the SMS app 1310 with a prepared SMS destination and content. However, this approach is unlikely to succeed, as it needs to be approved by the user on the screen, and thus the user will be fully aware of the attack.

### Proactive SIM SMS

An SMS may also be generated from a SIM card proactively by the embedded logic in the SIM defined by the mobile operators or supply-chain attackers. For example, the SIM may generate a proactive SMS request to the RIL through a unique SIM-RIL channel (e.g., UiccSmsController). Upon receiving the request, the RIL may proceed to send out an SMS message specified in the request payload. Similar to the aforementioned malware SMS and non-interactive binary SMS, a difference between a proactive SIM SMS and a benign SMS is that the former is directly initiated from the SIM to the RIL without user consent. As a result, the intent-aware detection approach may be applied to intercept such an SMS attempt at the RIL:

$$( sms . src = Sim ) \to S M S ( ProactiveSim )$$

In the event RILDEFENDER detects an outbound SMS generated from the SIM, the inline mediator may be invoked to prevent the SMS from being delivered to the baseband.

RILDEFENDER may handle IMS-based SMS in a similar way based on the RIL workflow. Also, for example, RILDEFENDER may be extended for legacy or future Android OS versions with minimal manual effort, due to the stable architecture of RIL and the standard Android APIs used in the implementations. For instance, as shown in table 1400 of FIG. 14, RILDEFENDER's implementation on AOSP11 is directly compatible with AOSP12 without any changes. While the implementation is described in the context of the six types of SMS attacks, RILDEFENDER's generic design allows it to be extensible for new attack signatures and policies at a very low cost.

Silent SMS has been used for tracking in some countries by law enforcement. RILDEFENDER does not attempt to distinguish between such SMS from attack SMS. However, balancing individual privacy and providing law-enforcement access to data has been a vexing and controversial issue, as exemplified by research in cryptography and anonymity networks. Therefore, RILDEFENDER is designed with a particular focus on user privacy, and extending it to support law enforcement (and other potential benign use cases) may be implemented.

### Example Evaluations

In some embodiments, RILDEFENDER may be implemented on three Android UEs with five different Android versions of the Android Open Source Project (AOSP).

FIG. 14 displays table 1400 listing details of the implementations, in accordance with example embodiments. First column 14C1 lists a device, second column 14C2 lists the corresponding chipset, third column 14C3 lists the OS version, fourth column 14C4 lists the AOSP build, and fifth column 14C5 lists the LoC statistics. As illustrated in third column 14C3, for NEXUS6R and PIXELXLX, Android versions (10.0.0 and 7.1.1) may be used, and for PIXEL5%, Android versions (11, 12, and 13) may be used. The implementations may be evaluated in the context of the following example inquiries: (i) can RILDEFENDER effectively detect and mitigate all six types of attacks in table 300 of FIG. 3 with no false negatives? (ii) could RILDEFENDER incorrectly block benign cellular operations in practice, or does it manifest false positives? And (iii) what is an overhead (power, memory, storage, and computation) introduced by RILDEFENDER?

To answer (i), the robustness of RILDEFENDER may be evaluated by testing it with reproduced SMS attacks and real-world SMS malware. To answer (ii), it may be tested whether RILDEFENDER incorrectly classifies benign cellular operations as attack behaviors with real-world trace analysis. To answer (iii), the overhead imposed by RILDEFENDER to the system may be measured, including the power consumption, memory, storage, and computation.

### Experiment Setup

To evaluate RILDEFENDER, the SMS attacks listed in FIG. 3 may be replicated. To this end, a BladeRF 2.0×A9 software-defined radio (SDR) and the open-source GSM cellular software YateBTS may be used to establish a private SMS testbed. To ensure that real-world devices and SMSCs are not impacted, the transmission power of the SDR may be minimized, and the subscriber list may be configured such that SDR may not connect with devices other that the testing devices.

### Robustness (FN) Evaluation

A robustness evaluation may be performed to test whether RILDEFENDER can correctly recognize and mitigate the aforementioned SMS attacks.

FIG. 15 displays table 1500 illustrating SMS test cases, in accordance with example embodiments. For example, as illustrated in table 1500, RILDEFENDER may be evaluated with 19 reproduced SMS test cases, 4 open-source remote access trojans (RAT), and 11 real-world SMS malware samples. Each type of SMS attack may require multiple test cases (e.g., different binary SMS variants). RILDEFENDER is able to correctly recognize and mitigate the SMS attacks on the five implementations (i.e., no FN). The test cases may be designed as described below:

Binary SMS attacks may be interactive or non-interactive. Correspondingly, table 1500 shows the eight variants for interactive binary SMS cases, and two variants for non-interactive binary SMS, with different proactive commands. RILDEFENDER may successfully detect and mitigate them. For non-interactive binary SMS attacks, RILDEFENDER is unable to block them as they are handled by the baseband approach described previously; however, RILDEFENDER is able to detect the attacks and generate notifications as expected.

Silent and flash SMS both require one test case, based on their definitions. Specifically, silent and flash SMS attacks may be reproduced by specifying the PID and DCS fields as illustrated in table 1500.

For FBS SMS, different cellular network parameters may be used to generate FBS SMS test cases. As shown in table 1500, the SDR may be configured to generate attack SMS with high signal strength (>−40 dBm) and illegal identity parameters (mobile country code (MCC) and mobile network code (MNC)). Based on these FBS configurations, silent, binary, and flash SMS attacks may be generated, demonstrating another feasible path for exploitation. MNC* and MCC* stand for illegal values.

As proactive SIM SMS depends on the specific SIM logic, it is not realistic to test all available SIMs worldwide. Therefore, three activated SIM cards coming from three major U.S. cellular providers may be tested. One of the SIM cards include proactive SIM SMS logic that can be easily triggered. For example, a proactive SIM SMS can be generated when the SIM is inserted to the UE. RILDEFENDER can effectively detect and mitigate this type of SMS.

FIG. 16 displays table 1600 illustrating malware SMS test cases, in accordance with example embodiments. For example, RILDEFENDER may be tested with two types of SMS malware: (1) open-source remote access trojans (RAT) from a public list, and (2) real-world SMS malware samples after 2020 from the MITRE list. Generally, real-world malware samples may not be publicly available, and 11 out of 15 were successfully acquired. Besides, only a few RAT tools in the list are open-source, compilable, and involve SMS exploits. Four open-source RATs appeared to match the testing parameters. Specifically, a RAT works by instructing the victim UE to open a communication channel (e.g., TCP sockets) to the malware producer, enabling remote control of the UE. Real-world malware samples are more heterogeneous and sophisticated, and they often include obfuscated code to exfiltrate contact data and send SMS messages without user's consent for malware propagation or spoofing.

### Correctness (FP) Evaluation

To evaluate whether RILDEFENDER may incorrectly classify benign cellular functions as attack behaviors, the correctness of RILDEFENDER may be evaluated with real-world trace analysis by conducting a 7-day test campaign with RILDEFENDER on the five implementations. During the experiment, all devices may be maintained under the same cellular settings and may receive SMS and voice calls in the wild. Received events may be plotted graphically during the tests, and RILDEFENDER's decisions appear to be correct, indicating no benign events under the categorization were mistakenly blocked (i.e., no FP). Also, for example, RILDEFENDER captured nine special SMS events in the wild, thereby demonstrating RILDEFENDER's capability to detect and prevent practical SMS attacks. The SMS events include two silent SMS, six proactive SIM SMS, and one binary SMS detected on the three devices. In particular, proactive SIM SMS messages were triggered right after the SIM was inserted into the UEs to start the tests. The destination addresses of these special SMS appear to be unusual three or four-digit private IDs that are likely owned by the carrier. As there is no public documentation about these SMS, they are likely related to carrier-specific functions (e.g., to configure UE settings and silently ping the device).

### Overhead Evaluation

Some aspects of the RILDEFENDER's overhead introduced to the vanilla AOSP may be evaluated, namely power, memory, storage, and computation. Measurements may be performed under three experimental settings: (1) vanilla AOSP (as the baseline), (2) AOSP with RILDEFENDER only, and (3) AOSP with RILDEFENDER and the baseband monitor (BM).

Power. The power consumption overhead of each of the five implementations may be evaluated. The tested UEs were under the same device settings and network, with their screens, Wi-Fi and Bluetooth functions switched off. For each test, the average battery usage may be plotted graphically over time for 10 hours. Due to the discrepancies in battery capacity, RILDEFENDER's overhead for each Android device model may be different. For Nexus 6 (AOSP 7.1.1), RILDEFENDER consumed 3%, 3%, and 13% of the total battery capacity in 10 hours for setting (1), (2), and (3), respectively. Pixel XL (AOSP 10.0.0) exhibits a similar power consumption, with 2%, 3%, and 12% under each of the three settings. As the battery capacity of Pixel 5 is significantly larger, the battery percentages consumed by RILDEFENDER may be smaller. Among the three RILDEFENDER implementations (i.e., AOSP 11, 12, and 13), the average power consumption is nearly 1% for settings (1), and (2), and 3% for setting (3).

RILDEFENDER and BM appear to impose approximately 1% battery consumption per hour on the tested devices in the worst-case scenario. However, the power consumption of RILDEFENDER is negligible, as it is nearly 0.1% per hour, 9×smaller than with RILDEFENDER and BM combined. The results indicate that the BM contributes most to the power consumption, as it needs to periodically poll and interpret baseband traffic. One possible optimization is to enlarge the baseband polling frequency discussed in Appendix § A.

Memory. To have a comparison baseline, the memory consumption of the telephony system process may be measured for setting (1). For settings (2) and (3), the memory usage of the telephony process may be measured with the RILDEFENDER and BM services deployed. It appears that RILDEFENDER and BM collectively introduce an average memory overhead of 40 MB among the five implementations. Such overhead only accounts for less than 1% of the device's total RAM (i.e., 4 GB, 3 GB, and 8 GB for Pixel XL, Nexus 6, and Pixel 5, respectively).

Storage. A size of the compiled AOSP system image may be measured before and after integrating RILDEFENDER and the BM. RILDEFENDER and BM appear to introduce an additional 5.5% storage overhead on average for the five implementations. Such overhead is likely caused by the RILDEFENDER app and the baseband monitor component. The discrepancies in storage overhead are likely caused by the slightly different implementations, as reflected in the LoC statistics in table 1400 of FIG. 14. For instance, a handful of telephony and notification APIs may be unavailable in Android 7.1.1.

Computation. An execution time of four cellular operations (inbound/outbound voice call and SMS) may be measured as RILDEFENDER requires to insert control logic at the RIL for them, which brings additional overhead in computation. A distribution of the computation time under different operations under settings (1) and (3) for the five implementations indicates that RILDEFENDER imposes an acceptable overhead, with an average execution time overhead of 9.6% among test cases. In the worst-case scenario (i.e., outbound voice call for AOSP12 on Pixel 5), the average overhead is less than 100 ms, indicating a very small delay for the operation. In summary, the computation overhead introduced by RILDEFENDER and BM may be considered negligible as it is nearly transparent to end-users even in the worst-case scenario (i.e., a 100 ms delay).

As described herein, RILDEFENDER is an inline defensive service integrated into an interface layer of smartphone UEs to monitor SMS related data at the baseband and the app layer. RILDEFENDER is distinguished from existing UE-centric defenses in that its approach provides both detection and effective inline defense capabilities to thwart incoming SMS threats, and is broadly applicable across heterogeneous smartphone OS. An implementation of RILDEFENDER on three UEs with five different Android versions of AOSP is provided. Also, for example, RILDEFENDER has been evaluated by using 19 reproduced SMS attack cases and 11 real-world SMS malware samples. The evaluation demonstrates that RILDEFENDER can detect all six types of SMS attacks across four different adversary models, and can automatically mitigate all but one in real-time. In the worst-case scenario, RILDEFENDER imposed an hourly battery consumption overhead of 1% and 100 ms delay for cellular operations on our tested devices.

### Example Network Environment

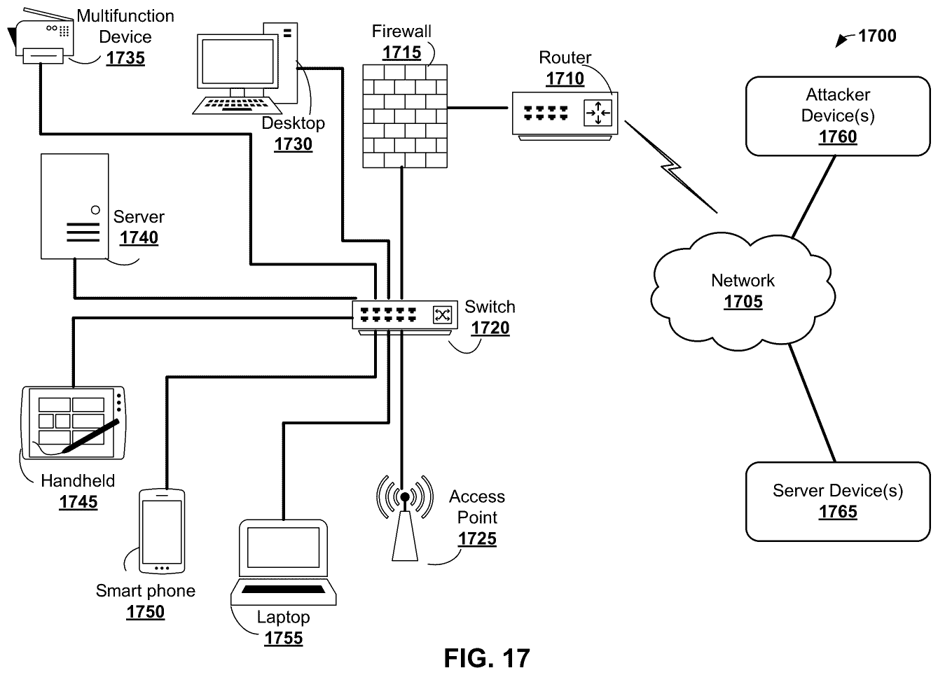

FIG. 17 depicts a network environment 1700, in accordance with example embodiments. Network environment 1700 includes network 1705, attacker device(s) 1760, and server device(s) 1765, that are configured to communicate, via network 1705, with one or more devices such as a desktop 1730, a device 1735, a server 1740, a handheld device 1745, a smart phone 1750, and/or a laptop 1755.

Network 1705 may correspond to a local area network (LAN), a wide area network (WAN), a WLAN, a WWAN, a corporate intranet, the public Internet, or any other type of network configured to provide a communications path between networked computing devices. Network 1705 may also correspond to a combination of one or more LANs, WANs, corporate intranets, and/or the public Internet.

The network environment 1700 may include tens, hundreds, or thousands of devices. In some examples, the one or more devices can be directly connected to network 1705. In other examples, the devices can be indirectly connected to network 1705 via router 1710, firewall 1715, network switch 1720, and/or access point 1725. In this example, router 1710, firewall 1715, network switch 1720, and/or access point 1725 can act as an associated computing device to pass electronic communications between the one or more devices and network 1705. Although an example physical topology of network 1705 is illustrated in FIG. 17, it is understood that network 1705 may be associated with a logical topology for data flow between physical components of network 1705.

Router 1710 can be configured to transmit packets by processing routing information included in a packet (e.g., Internet protocol (IP) data from layer 3). The routing information can be processed via a routing table. Firewall 1715 is a network device that can be configured to control network security and access rules. Network switch 1720 can be a single switch or an array of switches. Switch 520 is a network device that can be configured to connect various devices on a network, such as, for example, desktop 1730, device 1735, server 1740, handheld device 1745, smart phone 1750, and/or laptop 1755. Switch 520 can use packet switching to receive and forward data between devices in a network. Access point 1725 is a network device that can be configured to provide wireless access to various devices on the network.

Server devices 1765 can be configured to perform one or more services, as requested by the one or more devices. For example, server device 1765 can provide content to the one or more devices. The content can include, but is not limited to, content available over the World Wide Web (WWW), content from a dedicated server, software, images, audio, and/or video. The content can include confidential information. Although server 1740 is shown as a single server, it can represent a plurality of servers, and/or a data center comprising a plurality of servers.

In some embodiments, attacker device 1760 can be a device that performs penetration and intrusion acts that target wireless networks in one or more devices (e.g., network provided by access point 1725) to capture and/or intercept information exchanged over the network and/or intrude with the traffic of information.

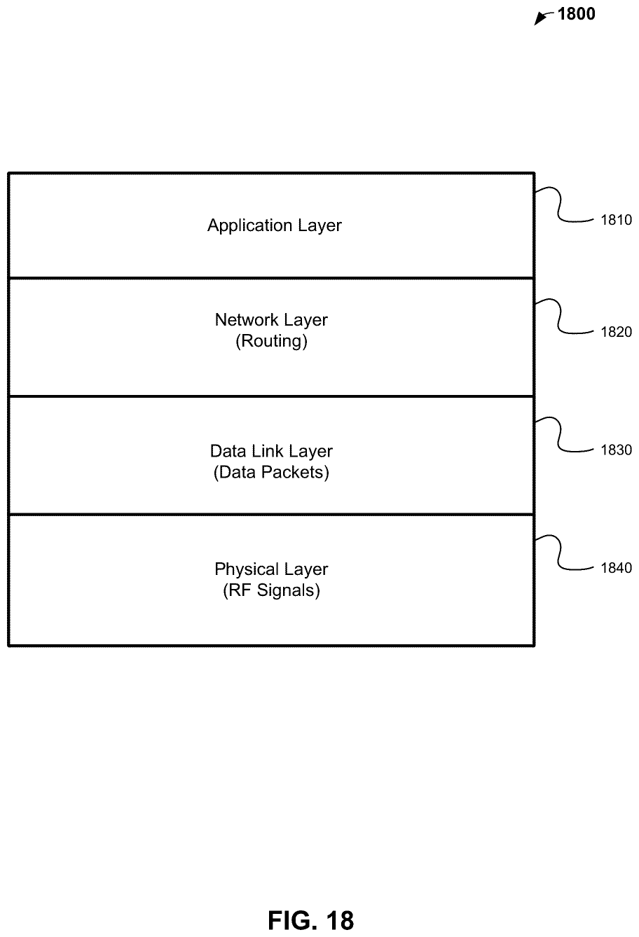

FIG. 18 depicts a protocol stack 1800, in accordance with example embodiments. The protocol stack 1800 enables nodes in a packet-switched network (e.g., network environment 1700) to communicate with one another. The term “node” can refer to any computing device in a network, including wireless access points, wireless devices, etc. Protocols that implement a packet-switched network divide messages into packets before the messages are sent. Each packet contains the source and destination addresses and the data. Each packet is then transmitted individually and can follow different routes to its destination. The original message is recompiled at the destination after all the packets forming the message arrive.

Network communication among the nodes (and wireless access points) is generally conceptualized in terms of protocol layers, such as the physical layer 1840, data link layer 1830, network layer 1820, and application layers 1810, and such protocol layers form a protocol stack 1800. In general, the protocol layers exchange control and status information with one another. For a node transmitting a communication, control starts at the application layer 1810 and passes layer by layer to the physical layer 1840, which sends the communication over a communication link to a receiving node. The receiving node processes the communication, layer by layer, up the stack of protocol layers, starting at the physical layer 1840 and ending at the application layer 1810. It is to be understood that the protocol stack 1800 can have additional protocol layers to those shown, such as a transport layer. The protocol used at the physical layer 1840 of the protocol stack 1800 accommodates the type of physical medium over which the nodes communicate. The physical layer 1840 conveys the bit stream in the radio signal through the network environment 1700 at the electrical and mechanical level, and provides the hardware means of sending and receiving data.

In one embodiment, the nodes in network environment 1700 communicate with each other over links using an IEEE 802.11 wireless communications standard (e.g., IEEE 802.11(a), IEEE 802.11(b), and IEEE 802.11(g)). Other embodiments of wireless communications standards that can be used by the nodes include BLUETOOTH, HYPERLAN, and HomeRF. For a node operating according to the IEEE 802.11, the physical layer 1840 specifies the physical aspects of the radio signaling (e.g., frequency hopping spread spectrum (FHSS), and direct sequence spread spectrum (DSSS)).

The data link layer 1830 encodes and decodes data packets into bits and handles errors in the physical layer 1840, flow control and frame synchronization. In one embodiment, the data link layer 1830 comprises two sub-layers: a Logical Link Control (LLC) layer and a Media Access Control (MAC) layer (the lower of the two sub-layers). The MAC sub-layer controls access to the physical transmission medium; the LLC layer controls frame synchronization, flow control, and error checking. The network (or routing) layer 1820 provides a protocol for forwarding and routing packets through the network environment 1700, by creating logical paths for transmitting packets from node to node.

### Example Computing Device

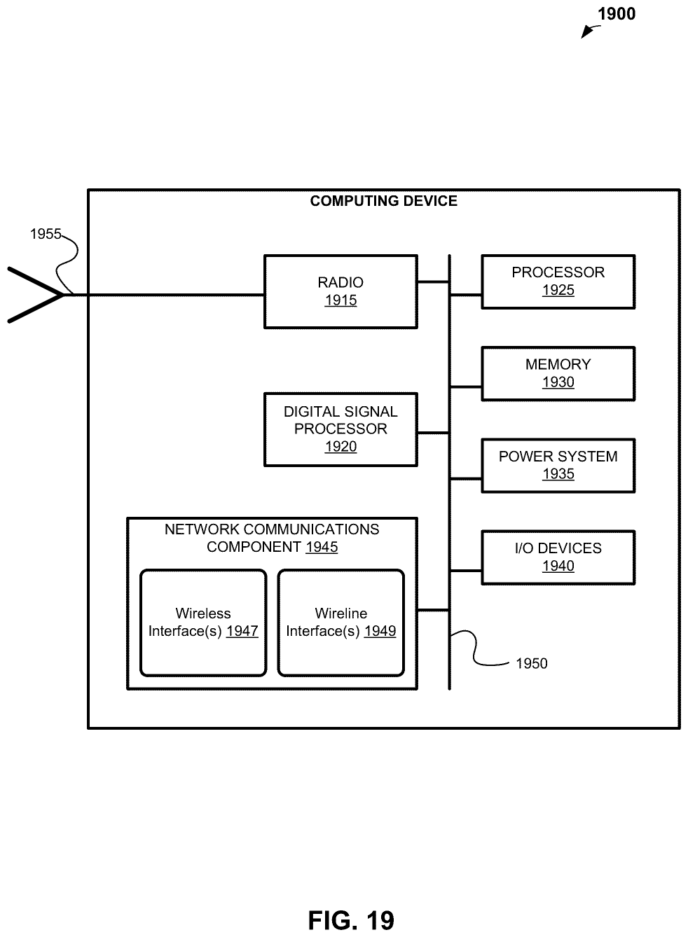

FIG. 19 is a block diagram of an example computing device 1900, in accordance with example embodiments. Computing device 1900 can include a radio 1915, a digital signal processor 1920, one or more processors 1925, memory 1930, power system 1935, input/output devices 1940, and network communications component 1945, all of which may be linked together via a system bus, network, or other connection mechanism 1950, and an antenna 1955 to communicate with a wireless access point or base station. Computing device 1900 can be one or more of the devices described with reference to FIG. 17 (e.g., desktop 1730, a device 1735, a server 1740, a handheld device 1745, a smart phone 1750, and/or a laptop 1755) or first UE 105A, second UE 105B of FIG. 1.

Radio 1915 may be a single physical layer (L1) interface that enables access to wireless media. A software driver can implement Media Access Control (MAC) functionality at layer-2 (L2) of an Open System Interconnect (OSI) standard to instantiate multiple simultaneous virtual network interfaces. Radio 1915 may be coupled to antenna 1955. A Digital Signal Processor (DSP) 1920 may be coupled to the radio 1915 and a Central Processing Unit (e.g., processor 1925). A media access controller (MAC) may be a separate chip or may be integrated into processor 1925.

One or more processors 1925 can include one or more general purpose processors, and/or one or more special purpose processors (e.g., digital signal processors, graphics processing units (GPUs), application specific integrated circuits, etc.). One or more processors 1925 can be configured to execute computer-readable instructions that are contained in memory 1930 and/or other instructions as described herein. The computer-executable instructions, when executed by the one or more processors 1925, cause the computing device to perform operations. The operations include monitoring, by a security component of the computing device, data related to SMS interactions over a radio network, wherein the security component is located in an abstraction layer between radio hardware and an operating system (OS). The operations also include, based on the monitoring, detecting a potential activity associated with an SMS interaction. The operations additionally include providing an indication of the potential activity.

In some embodiments, the computing device may include an application processor configured to execute the OS. In some embodiments, the OS may include an Android-based OS or an Apple-based OS. In some embodiments, the OS may include an Android-based OS, and the abstraction layer may include a radio interface layer (RIL).

In some embodiments, the operations may include mitigating a potential malicious activity.

In some embodiments, the operations providing the indication of the potential activity may include generating an alert associated with a potential malicious activity.

In some embodiments, the operations may include interacting with one or more user-space applications to track a context associated with the SMS interaction.

Memory 1930 can include one or more non-transitory computer-readable storage media that can be read and/or accessed by at least one of one or more processors 1925. The one or more computer-readable storage media can include volatile and/or non-volatile storage components, such as optical, magnetic, organic or other memory or disc storage, which can be integrated in whole or in part with at least one of one or more processors 1925. In some examples, memory 1930 can be implemented using a single physical device (e.g., one optical, magnetic, organic or other memory or disc storage unit), while in other examples, memory 1930 can be implemented using two or more physical devices.

Power system 1935 can include one or more batteries and/or one or more external power interfaces for providing electrical power to computing device 1900. One or more external power interfaces of power system 1935 can include one or more wired-power interfaces, such as a USB cable and/or a power cord, that enable wired electrical power connections to one or more power supplies that are external to computing device 1900.

Input/output devices 1940 may include storage devices, a receiver, a transmitter, a speaker, a display, an image capturing component, an audio recording component, a user input device (e.g., a keyboard, a mouse, a microphone), and so forth. Although not shown in FIG. 19, one or more of I/O devices 1940 may be a device external to computing device 1900. Such an external device may communicate with computing device 1900 via a wired or wireless connection, and such communication may be facilitated by an I/O interface of computing device 1900.

Network communications component 1945 can include one or more devices that provide one or more wireless interfaces 1947 and/or one or more wireline interfaces 1949 that are configurable to communicate via a network. Wireless interface(s) 1947 can include one or more wireless transmitters, receivers, and/or transceivers, such as a Bluetooth™ transceiver, a Wi-Fi™ transceiver, an LTE™ transceiver, and/or other type of wireless transceiver configurable to communicate via a wireless network. Wireline interface(s) 1949 can include one or more wireline transmitters, receivers, and/or transceivers, such as an Ethernet transceiver, a Universal Serial Bus (USB) transceiver, or similar transceiver configurable to communicate via a physical connection to a wireline network.

Network communications component 1945 can be configured to provide reliable, secured, and/or authenticated communications between various components. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information). Communications can be made secure (e.g., be encoded or encrypted) and/or decrypted/decoded using one or more cryptographic protocols and/or algorithms, such as, but not limited to, a secure sockets protocol such as Secure Sockets Layer (SSL), and/or Transport Layer Security (TLS).

### Example Methods of Operation

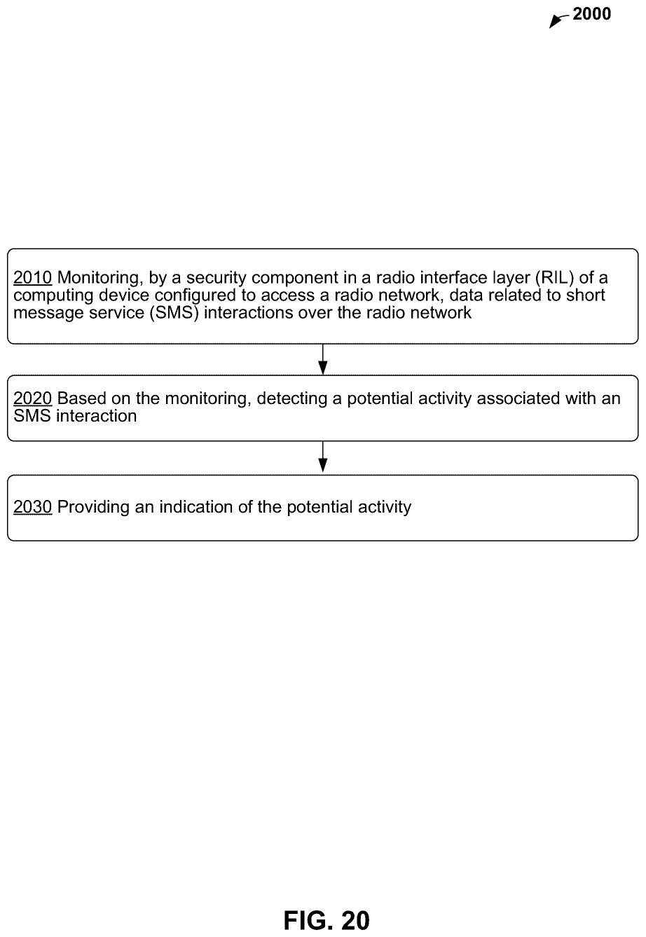

FIG. 20 illustrates an example method 2000, in accordance with example embodiments. Method 2000 may include various blocks or steps for defending, preventing, and/or mitigating short message service (SMS) based activities. The blocks or steps may be carried out individually or in combination. The blocks or steps may be carried out in any order and/or in series or in parallel. Further, blocks or steps may be omitted or added to method 2000.

The blocks of method 2000 may be carried out by various elements of computing device 1900 as illustrated and described in reference to FIG. 19.

Block 2010 includes monitoring, by a security component in a radio interface layer (RIL) of a computing device configured to access a radio network, data related to SMS interactions over the radio network.

Block 2020 includes, based on the monitoring, detecting a potential activity associated with an SMS interaction.

Block 2030 includes providing an indication of the potential activity.

Some embodiments involve mitigating a potential malicious activity. In some embodiments, the mitigating of the potential malicious activity may include one of blocking, allowing, rewriting, or forwarding of the SMS interaction.

In some embodiments, the providing of the indication of the potential activity may include generating an alert associated with a potential malicious activity.

In some embodiments, the providing of the indication of the potential activity may include identifying that the SMS interaction is a malicious activity initiated by a particular computing device. Such embodiments may include triggering an action to mitigate the malicious activity.

Some embodiments may include identifying a source of an outbound SMS based on inter-process communication calls to a user-space application.

Some embodiments may include monitoring baseband traffic from a proprietary protocol based on the diagnostic interface.

Some embodiments may include interacting with one or more user-space applications to track a context associated with the SMS interaction.

In some embodiments, the detecting of the potential activity includes detecting a baseband-only malicious attack.

In some embodiments, the data related to the SMS interactions includes context data. Some embodiments may include retrieving the context data from a system layer, wherein the context data is associated with a broadcast station, and wherein the context data relates to one or more of a signal strength or a broadcast parameter.

In some embodiments, an operating system (OS) of the computing device comprises an Android-based OS or an Apple-based OS.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information and/or comparison of signals can correspond to circuitry that can be configured to perform the specific logical functions of a herein-described method or technique. Alternatively or additionally, a step or block that represents a processing of information and/or comparison of signals can correspond to a component, a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A component may be implemented in hardware electronic components, software components, and a combination of both.

Generally, application includes programs, routines, objects, widgets, plug-ins, and other similar structures that perform particular tasks or implement particular abstract data types. Those skilled in the art can implement the description and/or figures herein as computer-executable instructions, which can be embodied on any form of computing machine-readable media discussed herein.

Many functions performed by electronic hardware components can be duplicated by software emulation. Thus, a software program written to accomplish those same functions can emulate the functionality of the hardware components in input-output circuitry.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method for defending, preventing, and/or mitigating short message service (SMS) based activities, comprising:
monitoring, by a security component in a radio interface layer (RIL) of a computing device configured to access a radio network, data related to SMS interactions over the radio network;
based on the monitoring, detecting a potential activity associated with an SMS interaction; and
providing an indication of the potential activity.

2. The computer-implemented method of claim 1, further comprising:
mitigating a potential malicious activity.

3. The computer-implemented method of claim 2, wherein the mitigating of the potential malicious activity further comprises one of blocking, allowing, rewriting, or forwarding of the SMS interaction.

4. The computer-implemented method of claim 1, wherein the providing of the indication of the potential activity further comprising:
generating an alert associated with a potential malicious activity.

5. The computer-implemented method of claim 1, wherein the providing of the indication of the potential activity further comprising:
identifying that the SMS interaction is a malicious activity initiated by a particular computing device; and
triggering an action to mitigate the malicious activity.

6. The computer-implemented method of claim 1, further comprising:
identifying a source of an outbound SMS based on inter-process communication calls to a user-space application.

7. The computer-implemented method of claim 1, further comprising:
monitoring baseband traffic from a proprietary protocol based on a diagnostic interface.

8. The computer-implemented method of claim 1, further comprising:
interacting with one or more user-space applications to track a context associated with the SMS interaction.

9. The computer-implemented method of claim 1, wherein the detecting of the potential activity comprises detecting a baseband-only malicious attack.

10. The computer-implemented method of claim 1, wherein the data related to the SMS interactions comprises context data.

11. The computer-implemented method of claim 10, further comprising:
retrieving the context data from a system layer, wherein the context data is associated with a broadcast station, and wherein the context data relates to one or more of a signal strength or a broadcast parameter.

12. The computer-implemented method of claim 1, wherein an operating system (OS) of the computing device comprises an Android-based OS or an Apple-based OS.

13. A computing device for defending, preventing, and/or mitigating short message service (SMS) based activities, comprising:
one or more processors; and
data storage, wherein the data storage has stored thereon computer-executable instructions that, when executed by the one or more processors, cause the computing device to carry out operations comprising:
monitoring, by a security component of the computing device, data related to SMS interactions over a radio network, wherein the security component is located in an abstraction layer between radio hardware and an operating system (OS);
based on the monitoring, detecting a potential activity associated with an SMS interaction; and
providing an indication of the potential activity.

14. The computing device of claim 13, further comprising an application processor configured to execute the OS.

15. The computing device of claim 14, wherein the OS comprises an Android-based OS or an Apple-based OS.

16. The computing device of claim 14, wherein the OS comprises an Android-based OS, and wherein the abstraction layer comprises a radio interface layer (RIL).

17. The computing device of claim 13, the operations further comprising:
mitigating a potential malicious activity.

18. The computing device of claim 13, wherein the operations providing the indication of the potential activity further comprising:
generating an alert associated with a potential malicious activity.

19. The computing device of claim 13, the operations further comprising:
interacting with one or more user-space applications to track a context associated with the SMS interaction.

20. A non-transitory computer-readable medium for defending, preventing, and/or mitigating short message service (SMS) based activities, comprising program instructions executable by one or more processors to cause the one or more processors to perform operations comprising:
monitoring, by a security component of a computing device, data related to SMS interactions over a radio network, wherein the security component is located in an abstraction layer between radio hardware and an operating system (OS);
based on the monitoring, detecting a potential activity associated with an SMS interaction; and
providing an indication of the potential activity.

21. The non-transitory computer-readable medium of claim 20, wherein the computing device comprises an application processor configured to execute an operating system (OS) of the computing device.
